(19) United States
(12) Patent Application Publication
(10) Pub. No.: US 2023/0042065 A1
(43) Pub. Date: Feb. 9, 2023

(54) INDOOR AIR QUALITY (IAQ) ANALYSIS SYSTEM

(71) Applicant: Johnson Controls Tyco IP Holdings LLP, Milwaukee, WI (US)

(72) Inventors: Jonathan D. Douglas, Mequon, WI (US); Bernard P. Clement, Mequon, WI (US); Kirk H. Drees, Cedarburg, WI (US)

(21) Appl. No.: 17/882,283

(22) Filed: Aug. 5, 2022

Related U.S. Application Data
(60) Provisional application No. 63/394,536, filed on Aug. 2, 2022.
(60) Provisional application No. 63/230,608, filed on Aug. 6, 2021.

(51) Int. Cl. F24F 11/64; F24F 11/58; F24F 11/52

(52) U.S. Cl. CPC F24F 11/64; F24F 11/52; F24F 11/58; F24F 2110/64

(57) ABSTRACT

A building system can connect to temporary air quality sensors installed throughout spaces of the building for a period of time. The building system can receive air quality measurements of the temporary air quality sensors over the period of time and disconnect from the temporary air quality sensors at an end of the period of time, wherein the temporary air quality sensors are uninstalled at the end of the period of time. The building system can generate a control strategy based on the air quality measurements, the control strategy for controlling equipment of the building to improve air quality of the building and cause a building management system to implement the control strategy to control the equipment of the building to improve the air quality of the building.

### CROSS REFERENCE TO RELATED PATENT APPLICATION

This application claims the benefit of, and priority to, U.S. Provisional Application No. 63/230,608 filed August 6^{th}, 2021 and U.S. Provisional Application No. 63/394,536 filed August 2^{nd}, 2022, the entirety of which is incorporated by reference herein.

### BACKGROUND

This application relates generally to buildings. Buildings, such as schools, can include various spaces such as classrooms, conference rooms, zones, offices, hallways, etc. The air quality of the buildings can have an impact on the health of the occupants, tenants, students, teachers, or staff of the building. However, a building may not have a mechanism to measure the air quality of the building or improve the air quality of the building.

### SUMMARY

One implementation of the present disclosure is a building system for a building, the building system including one or more memory devices storing instructions thereon that, when executed by one or more processors, cause the one or more processors to connect to temporary air quality sensors installed throughout spaces of the building for a period of time. The instructions cause the one or more processors to receive air quality measurements of the temporary air quality sensors over the period of time and disconnect from the temporary air quality sensors at an end of the period of time, wherein the temporary air quality sensors are uninstalled at the end of the period of time. The instructions cause the one or more processors to generate a control strategy based on the air quality measurements, the control strategy for controlling equipment of the building to improve air quality of the building and cause a building management system to implement the control strategy to control the equipment of the building to improve the air quality of the building.

Another implementation of the present disclosure is a building system for a building, the building system including one or more memory devices storing instructions thereon that, when executed by one or more processors, cause the one or more processors to receive air quality measurements of temporary air quality sensors over a period of time. At least one of the temporary air quality sensors is configured to connect to a computing system, wherein the temporary air quality sensors are installed throughout spaces of the building for the period of time and disconnect from the computing system at an end of the period of time, wherein the temporary air quality sensors are uninstalled at the end of the period of time. The instructions cause the one or more processors to generate a control strategy based on the air quality measurements, the control strategy for controlling equipment of the building to improve air quality of the building.

In some embodiments, the air quality measurements are at least one of total volatile organic compounds (TVOC), carbon dioxide (CO2), carbon monoxide (CO), ozone, particulates, or formaldehyde.

In some embodiments, the instructions cause the one or more processors to receive indoor air quality measurements from the temporary air quality sensors of the spaces of the building, receive outdoor air quality measurements of outdoor air quality outside the building, generate air quality metrics for the spaces by comparing the indoor air quality measurements to the outdoor air quality measurements, and cause a display device of the a device to display the air quality metrics for the spaces.

In some embodiments, the air quality measurements include air quality metrics. In some embodiments, the instructions cause the one or more processors to generate trends of the air quality metrics and cause a display device of a user device to display the trends.

In some embodiments, the instructions cause the one or more processors to determine an infection risk for an infectious disease spreading in a population of the building based on the air quality measurements and perform one or more operations to reduce a spread of the infectious disease present in the population based on the infection risk.

In some embodiments, the building system is a cloud system located remote from the building, wherein the cloud system is configured to receive the air quality measurements via one or more wireless networks of the building, wherein the temporary air quality sensors are configured to wirelessly communicate via the one or more wireless networks.

In some embodiments, the instructions cause the one or more processors to generate an infectious disease report indicating a probability of a spread of an infectious disease in the spaces of the building based on the air quality measurements and cause a display device of a user device to display the infectious disease report.

In some embodiments, the building is a school building. In some embodiments, the instructions cause the one or more processors to generate the control strategy to reduce a spread of an infectious disease among students of the school building and cause the building management system to implement the control strategy to control the equipment of the school building to reduce the spread of the infectious disease among students of the school building.

In some embodiments, the instructions cause the one or more processors to receive outdoor air quality measurements of outdoor air quality outside the building, generate air quality metrics for the spaces by comparing indoor air quality measurements to the outdoor air quality measurements, and cause a display device of a user device to display the air quality metrics for the spaces.

In some embodiments, the air quality metrics are a ratio of the indoor air quality measurements to the outdoor air quality measurements.

In some embodiments, the instructions cause the one or more processors to generate a summary interface based on the air quality measurements, the summary interface including a single graphical interface comparing the air quality of the spaces of the building and temporal representations of levels of the air quality in the spaces of the building over a duration and cause a display device of a user device to display the summary interface.

In some embodiments, the summary interface is generated for a first air quality metric. In some embodiments, the instructions cause the one or more processors to generate a second summary interface based on the air quality measurements for a second air quality metric, the second summary interface including a second single chart comparing the second air quality metric of the spaces of the building and second temporal representations of levels of the second air quality metric in the spaces of the building over the duration.

In some embodiments, the single graphical interface is a bar chart including bars for the spaces, the bars including components indicating a percentage of time of the duration that the air quality is in a particular range of values.

In some embodiments, the single graphical interface is a table including rows and a columns. In some embodiments, the rows indicate the spaces of the building. In some embodiments, the columns indicate ranges of values of the air quality. In some embodiments, each intersection of the rows and the columns indicates a percentage of time that the air quality is in a particular range of values.

Another implementation of the present disclosure is a method including connecting, by one or more processing circuits, to temporary air quality sensors installed throughout spaces of a building for a period of time. The method includes receiving, by the one or more processing circuits, air quality measurements of the temporary air quality sensors over the period of time. The method includes disconnecting, by the one or more processing circuits, from the temporary air quality sensors at an end of the period of time, wherein the temporary air quality sensors are uninstalled at the end of the period of time. The method includes generating, by the one or more processing circuits, a control strategy based on the air quality measurements, the control strategy for controlling equipment of the building to improve air quality of the building. The method includes causing, by the one or more processing circuits, a building management system to implement the control strategy to control the equipment of the building to improve the air quality of the building.

Another implementation of the present disclosure is a method including receiving, by one or more processing circuits, air quality measurements of temporary air quality sensors over a period of time. At least one of the temporary air quality sensors is configured to connect to a computing system, wherein the temporary air quality sensors are installed throughout spaces of a building for the period of time and disconnect from the computing system at an end of the period of time, wherein the temporary air quality sensors are uninstalled at the end of the period of time. The method includes generating, by the one or more processing circuits, a control strategy based on the air quality measurements, the control strategy for controlling equipment of the building to improve air quality of the building.

In some embodiments, the method includes determining, by the one or more processing circuits, an infection risk for an infectious disease spreading in a population of the building based on the air quality measurements. In some embodiments, the method includes performing, by the one or more processing circuits, one or more operations to reduce a spread of the infectious disease present in the population based on the infection risk.

In some embodiments, the method includes generating, by the one or more processing circuits, a summary interface based on the air quality measurements, the summary interface including a single graphical interface comparing the air quality of the spaces of the building and temporal representations of levels of the air quality in the spaces of the building over a duration and causing, by the one or more processing circuits, a display device of a user device to display the summary interface.

In some embodiments, the single graphical interface is a bar chart including bars for the spaces, the bars including components indicating a percentage of time of the duration that the air quality is in a particular range of values.

In some embodiments, the single graphical interface is a table including rows and a columns. In some embodiments, the rows indicate the spaces of the building. In some embodiments, the columns indicate ranges of values of the air quality. In some embodiments, each intersection of the rows and the columns indicates a percentage of time that the air quality is in a particular range of values.

Another implementation of the present disclosure is one or more computer readable medium storing instructions thereon that, when executed by one or more processors, cause the one or more processors to connect to temporary air quality sensors installed throughout a spaces of a building for a period of time. The instructions cause the one or more processors to receive air quality measurements of the temporary air quality sensors over the period of time, disconnect from the temporary air quality sensors at an end of the period of time, wherein the temporary air quality sensors are uninstalled at the end of the period of time, generate a control strategy based on the air quality measurements, the control strategy for controlling equipment of the building to improve air quality of the building, and cause a building management system to implement the control strategy to control the equipment of the building to improve the air quality of the building.

Another implementation of the present disclosure is a building system for a building, the building system including one or more memory devices storing instructions thereon that, when executed by the one or more processors, cause the one or more processors to receive air quality measurements of a plurality of air quality sensors of a plurality of spaces of the building. The instructions cause the one or more processors to generate a summary interface based on the air quality measurements, the summary interface including a single graphical interface comparing the air quality of a plurality of spaces of the building and temporal representations of levels of the air quality in the plurality of different spaces of the building over a duration. The instructions cause the one or more processors to cause a display device of the user device to display the summary interface.

Another implementation of the present disclosure is a building system for a building, the building system including one or more memory devices storing instructions thereon that, when executed by the one or more processors, cause the one or more processors to receive indoor air quality measurements of a plurality of air quality sensors of a plurality of spaces of the building. The instructions cause the one or more processors to receive outdoor air quality measurements of outdoor air quality outside the building. The instructions cause the one or more processors to generate air quality metrics for the plurality of spaces by comparing the indoor air quality measurements to the outdoor air quality measurements. The instructions cause the one or more processors to cause a display device of the user device to display the air quality metrics for the plurality of spaces.

Another implementation of the present disclosure is a building system for a school building, the building system including one or more memory devices storing instructions thereon that, when executed by the one or more processors, cause the one or more processors to receive air quality measurements of a plurality of air quality sensors of a plurality of spaces of the building. The instructions cause the one or more processors to determine an infection risk for an infectious disease spreading a population of the plurality of spaces based on the air quality measurements. The instructions cause the one or more processors to perform one or more operations to reduce a spread of the infectious disease present in the population based on the infection risk.

Another implementation of the present disclosure is a building system for a building, the building system including one or more memory devices storing instructions thereon that, when executed by the one or more processors, cause the one or more processors to connect to a plurality of temporary air quality sensors installed throughout a plurality of spaces of the building for a period of time. The instructions cause the one or more processors to receive air quality measurements of the plurality of temporary air quality sensors over the period of time, generate one or more reports and/or recommendations based on the air quality measurements; and disconnect from the plurality of temporary air quality sensors at an end of the period of time, wherein the plurality of temporary air quality sensors are uninstalled at the end of the period of time.

Another implementation of the present disclosure is a building system for a building, the building system including one or more memory devices storing instructions thereon that, when executed by the one or more processors, cause the one or more processors to connect to a plurality of temporary air quality sensors installed throughout a plurality of spaces of the building for a period of time and receive air quality measurements of the plurality of temporary air quality sensors over the period of time. The instructions cause the one or more processors to generate an infectious disease report indicating a probability of a spread of an infectious disease in the plurality of spaces of the building based on the air quality measurements and disconnect from the plurality of temporary air quality sensors at an end of the period of time, wherein the plurality of temporary air quality sensors are uninstalled at the end of the period of time.

Another implementation of the present disclosure is a building system for a building, the building system including one or more memory devices storing instructions thereon that, when executed by the one or more processors, cause the one or more processors to connect to a plurality of temporary air quality sensors installed throughout a plurality of spaces of the building for a period of time. The instructions cause the one or more processors to receive air quality measurements of the plurality of temporary air quality sensors over the period of time. The instructions cause the one or more processors to generate a control strategy based on the air quality measurements, the control strategy for controlling equipment of the building to improve air quality of the school building, disconnect from the plurality of temporary air quality sensors at an end of the period of time, wherein the plurality of temporary air quality sensors are uninstalled at the end of the period of time, and cause a building management system to implement the control strategy to control the equipment of the building to improve the air quality of the school building.

Another implementation of the present disclosure is a building system for a building, the building system including one or more memory devices storing instructions thereon that, when executed by the one or more processors, cause the one or more processors to connect to a plurality of temporary air quality sensors installed throughout a plurality of spaces of the building for a period of time, receive air quality measurements of the plurality of temporary air quality sensors over the period of time, and generate a control strategy, based on the air quality measurements, the control strategy for controlling equipment of the school building to reduce a spread of an infectious disease among students of the school building. The instructions cause the one or more processors to disconnect from the plurality of temporary air quality sensors at an end of the period of time, wherein the plurality of temporary air quality sensors are uninstalled at the end of the period of time and cause a building management system to implement the control strategy to control the equipment of the school building to reduce a spread of an infectious disease among students of the school building.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to an exemplary embodiment.

FIG. 2 is a block diagram of a building automation system (BAS) that may be used to monitor and/or control the building of FIG. 1, according to an exemplary embodiment.

FIG. 3 is a block diagram of a school analysis system that generates recommendations and reports of spaces of a school building based on air quality measurements of sensors, according to an exemplary embodiment.

FIG. 4 is a flow diagram of a process where temporary air quality sensors are installed in spaces of a school building to collect air quality measurements of the spaces and generate one or more reports and/or recommendations, according to an exemplary embodiment.

FIGS. 5-8 are schematic diagrams of spaces of a school building and equipment of the school building, according to an exemplary embodiment.

FIG. 9 is a schematic diagram of a space of the school building including a fan, an air cleaner, and an infected student, according to an exemplary embodiment.

FIG. 10 is a chart of carbon dioxide (CO2) of an orchestra space of the school building, according to an exemplary embodiment.

FIG. 11 is a chart of CO2 of a zone of a library of the school building, according to an exemplary embodiment.

FIG. 12 is a chart of CO2 for a math room of the school building, according to an exemplary embodiment.

FIG. 13 is a chart of CO2, total volatile organic compounds (TVOC), and particulate matter (PM2.5) for the math room of FIG. 10, the chart indicating percentages of time of a duration that the CO2, TVOC, and PM2.5 were in particular ranges in the math room, according to an exemplary embodiment.

FIG. 14 is a table of specifications for the math room of FIG. 10, according to an exemplary embodiment.

FIG. 15 is a summary table of CO2 measurements for spaces of a school building, the summary table indicating a percentage of time of a duration that each of the spaces had CO2 measurements in various ranges, according to an exemplary embodiment.

FIG. 16 is a chart of CO2 measurements for spaces of a school building, the chart indicating a percentage of time of a duration that each of the spaces had CO2 measurements in various ranges, according to an exemplary embodiment.

FIG. 17 is a chart of TVOC for an office of the school building, according to an exemplary embodiment.

FIG. 18 is a chart of TVOC for a room of the school building, according to an exemplary embodiment.

FIG. 19 is a chart indicating TVOC measurements for an office of the school building, according to an exemplary embodiment.

FIG. 20 is a summary table of TVOC measurements for spaces of a school building, the summary table indicating a percentage of time of a duration that each of the spaces had TVOC measurements in various ranges, according to an exemplary embodiment.

FIG. 21 is a chart of TVOC measurements for spaces of a school building, the chart indicating a percentage of time of a duration that each of the spaces had TVOC measurements in various ranges, according to an exemplary embodiment.

FIG. 22 is a chart of outdoor PM2.5 and indoor PM2.5 of a school building, according to an exemplary embodiment.

FIG. 23 is a chart of PM2.5 particulate for a first room of the school building, according to an exemplary embodiment.

FIG. 24 is a PM2.5 particulate of a second room of the school building, according to an exemplary embodiment.

FIG. 25 is a PM2.5 particulate of a third room of the school building, according to an exemplary embodiment.

FIG. 26 is a summary table of PM2.5 particulate for various spaces of the building indicating percentages of time that a ratio of indoor PM2.5 particulate to outdoor PM2.5 particulate is in particular ranges, according to an exemplary embodiment.

FIG. 27 is a chart of PM2.5 particulate for various spaces of the building indicating percentages of time that a ratio of indoor PM2.5 particulate to outdoor PM2.5 particulate is in particular ranges, according to an exemplary embodiment.

FIG. 28 is another chart of PM2.5 particulate for various spaces of the building indicating percentages of time that a ratio of indoor PM2.5 particulate to outdoor PM2.5 particulate is in particular ranges, according to an exemplary embodiment.

FIG. 29 is a drawing of smoke from fires moving across a country, according to an exemplary embodiment.

FIG. 30 is a chart of outdoor air quality corresponding to the smoke shown in FIG. 24, according to an exemplary embodiment.

### DETAILED DESCRIPTION

Referring generally to the FIGURES, systems and methods are provided by monitoring air quality in a building with multiple spaces. According to various example embodiments, sensors may be deployed into multiple spaces and used over a period of time to collect data regarding the air quality in the spaces. In some embodiments, the sensors may be deployed temporarily (e.g., as a service) and removed at the end of the monitoring/test period. In some embodiments, the sensors may be permanently installed. The collected data may be used to generate insights as to the air quality of the spaces and actions that may be taken to improve the air quality or help protect the health of the occupants. While the present disclosure discusses various examples in the context of school buildings and classrooms, it should be noted that the features of the present disclosure are equally applicable to any type of building or group of buildings having multiple spaces into which sensors may be temporarily or permanently installed.

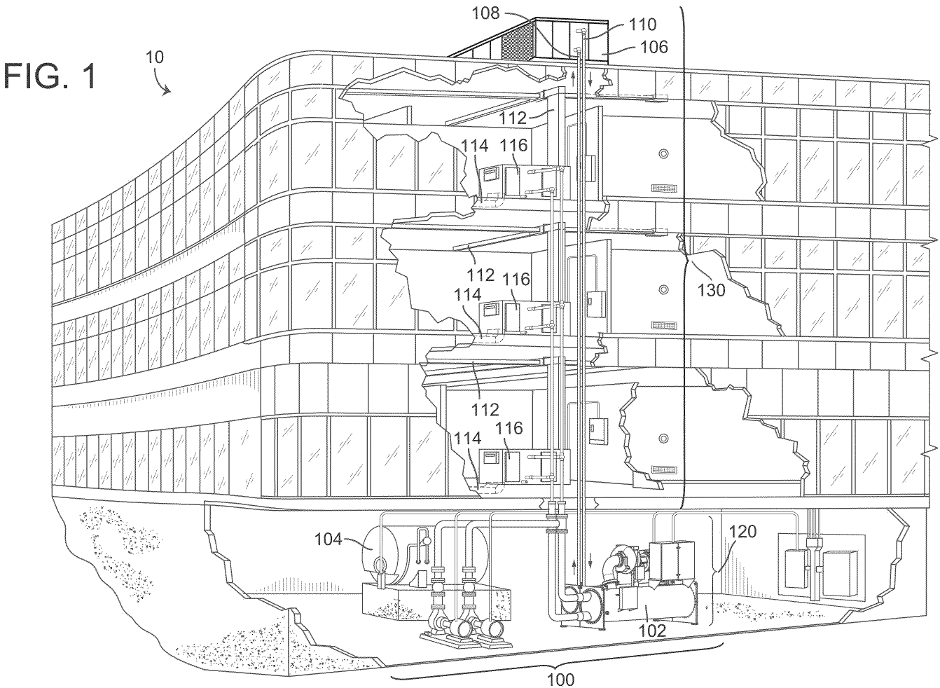

Referring now to FIG. 1, an exemplary building management system (BMS) and HVAC system in which the systems and methods of the present invention can be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, and/or any other system that is capable of managing building functions or devices, or any combination thereof.

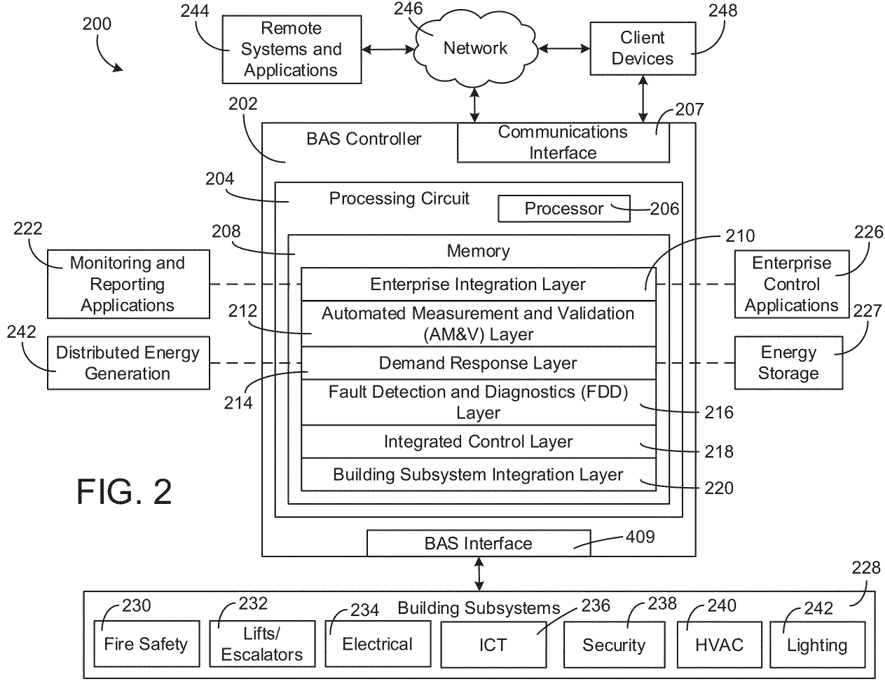

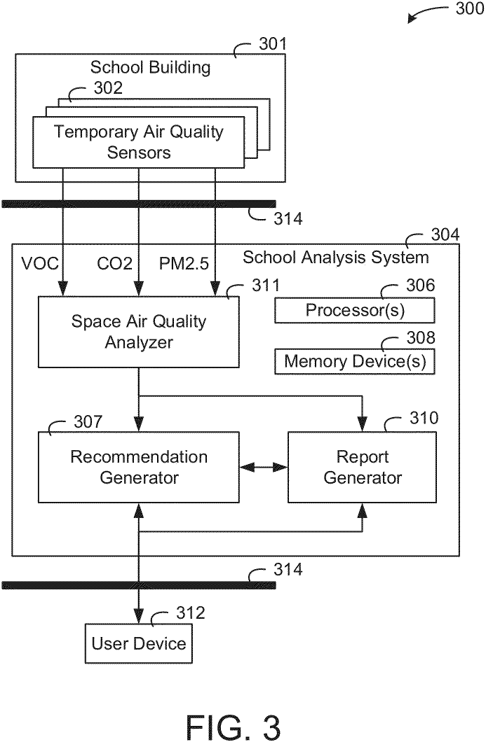

The BMS that serves building 10 includes an HVAC system 100. HVAC system 100 can include HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

Referring now to FIG. 2, a block diagram of a building automation system (BAS) 200 is shown, according to an exemplary embodiment. BAS 200 can be implemented in building 10 to automatically monitor and control various building functions. BAS 200 is shown to include building management system (BMS) or BAS controller 202 and building subsystems 228. Building subsystems 228 are shown to include a building electrical subsystem 234, an information communication technology (ICT) subsystem 236, a security subsystem 238, a HVAC subsystem 240, a lighting subsystem 242, a lift/escalators subsystem 232, and a fire safety subsystem 230. In various embodiments, building subsystems 228 can include fewer, additional, or alternative subsystems. For example, building subsystems 228 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 228 include a waterside system and/or an airside system. A waterside system and an airside system are described with further reference to U.S. Pat. Application No. 15/631,830 filed Jun. 23, 2017, the entirety of which is incorporated by reference herein.

Each of building subsystems 228 can include any number of devices, controllers, and connections for completing its individual functions and control activities. HVAC subsystem 240 can include many of the same components as HVAC system 100, as described with reference to FIG. 1. For example, HVAC subsystem 240 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 242 can include any number of light fixtures, ballasts, lighting sensors, dimmers, or other devices configured to controllably adjust the amount of light provided to a building space. Security subsystem 238 can include occupancy sensors, video surveillance cameras, digital video recorders, video processing servers, intrusion detection devices, access control devices and servers, or other security-related devices.

Still referring to FIG. 2, BAS controller 202 is shown to include a communications interface 207 and a BAS interface 209. Interface 207 can facilitate communications between BAS controller 202 and external applications (e.g., monitoring and reporting applications 222, enterprise control applications 226, remote systems and applications 244, applications residing on client devices 248, etc.) for allowing user control, monitoring, and adjustment to BAS controller 202 and/or subsystems 228. Interface 207 can also facilitate communications between BAS controller 202 and client devices 248. BAS interface 209 can facilitate communications between BAS controller 202 and building subsystems 228 (e.g., HVAC, lighting security, lifts, power distribution, business, etc.).

Interfaces 207, 209 can be or include wired or wireless communications interfaces (e.g., jacks, antennas, transmitters, receivers, transceivers, wire terminals, etc.) for conducting data communications with building subsystems 228 or other external systems or devices. In various embodiments, communications via interfaces 207, 209 can be direct (e.g., local wired or wireless communications) or via a communications network 246 (e.g., a WAN, the Internet, a cellular network, etc.). For example, interfaces 207, 209 can include an Ethernet card and port for sending and receiving data via an Ethernet-based communications link or network. In another example, interfaces 207, 209 can include a Wi-Fi transceiver for communicating via a wireless communications network. In another example, one or both of interfaces 207, 209 can include cellular or mobile phone communications transceivers. In one embodiment, communications interface 207 is a power line communications interface and BAS interface 209 is an Ethernet interface. In other embodiments, both communications interface 207 and BAS interface 209 are Ethernet interfaces or are the same Ethernet interface.

Still referring to FIG. 2, BAS controller 202 is shown to include a processing circuit 204 including a processor 206 and memory 208. Processing circuit 204 can be communicably connected to BAS interface 209 and/or communications interface 207 such that processing circuit 204 and the various components thereof can send and receive data via interfaces 207, 209. Processor 206 can be implemented as a general purpose processor, an application specific integrated circuit (ASIC), one or more field programmable gate arrays (FPGAs), a group of processing components, or other suitable electronic processing components.

Memory 208 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 208 can be or include volatile memory or non-volatile memory. Memory 208 can include database components, object code components, script components, or any other type of information structure for supporting the various activities and information structures described in the present application. According to an exemplary embodiment, memory 208 is communicably connected to processor 206 via processing circuit 204 and includes computer code for executing (e.g., by processing circuit 204 and/or processor 206) one or more processes described herein.

In some embodiments, BAS controller 202 is implemented within a single computer (e.g., one server, one housing, etc.). In various other embodiments BAS controller 202 can be distributed across multiple servers or computers (e.g., that can exist in distributed locations). Further, while FIG. 2 shows applications 222 and 226 as existing outside of BAS controller 202, in some embodiments, applications 222 and 226 can be hosted within BAS controller 202 (e.g., within memory 208).

Still referring to FIG. 2, memory 208 is shown to include an enterprise integration layer 210, an automated measurement and validation (AM&V) layer 212, a demand response (DR) layer 214, a fault detection and diagnostics (FDD) layer 216, an integrated control layer 218, and a building subsystem integration later 220. Layers 210-220 is configured to receive inputs from building subsystems 228 and other data sources, determine optimal control actions for building subsystems 228 based on the inputs, generate control signals based on the optimal control actions, and provide the generated control signals to building subsystems 228 in some embodiments. The following paragraphs describe some of the general functions performed by each of layers 210-220 in BAS 200.

Enterprise integration layer 210 can be configured to serve clients or local applications with information and services to support a variety of enterprise-level applications. For example, enterprise control applications 226 can be configured to provide subsystem-spanning control to a graphical user interface (GUI) or to any number of enterprise-level business applications (e.g., accounting systems, user identification systems, etc.). Enterprise control applications 226 can also or alternatively be configured to provide configuration GUIs for configuring BAS controller 202. In yet other embodiments, enterprise control applications 226 can work with layers 210-220 to optimize building performance (e.g., efficiency, energy use, comfort, or safety) based on inputs received at interface 207 and/or BAS interface 209.

Building subsystem integration layer 220 can be configured to manage communications between BAS controller 202 and building subsystems 228. For example, building subsystem integration layer 220 can receive sensor data and input signals from building subsystems 228 and provide output data and control signals to building subsystems 228. Building subsystem integration layer 220 can also be configured to manage communications between building subsystems 228. Building subsystem integration layer 220 translate communications (e.g., sensor data, input signals, output signals, etc.) across multi-vendor/multi-protocol systems.

Demand response layer 214 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 224, from energy storage 227, or from other sources. Demand response layer 214 can receive inputs from other layers of BAS controller 202 (e.g., building subsystem integration layer 220, integrated control layer 218, etc.). The inputs received from other layers can include environmental or sensor inputs such as temperature, CO2 levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an exemplary embodiment, demand response layer 214 includes control logic for responding to the data and signals it receives. These responses can include communicating with the control algorithms in integrated control layer 218, changing control strategies, changing setpoints, or activating/deactivating building equipment or subsystems in a controlled manner. Demand response layer 214 can also include control logic configured to determine when to utilize stored energy. For example, demand response layer 214 can determine to begin using energy from energy storage 227 just prior to the beginning of a peak use hour.

In some embodiments, demand response layer 214 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 214 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 214 can further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user’s application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable setpoint adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 218 can be configured to use the data input or output of building subsystem integration layer 220 and/or demand response later 214 to make control decisions. Due to the subsystem integration provided by building subsystem integration layer 220, integrated control layer 218 can integrate control activities of the subsystems 228 such that the subsystems 228 behave as a single integrated supersystem. In an exemplary embodiment, integrated control layer 218 includes control logic that uses inputs and outputs from building subsystems to provide greater comfort and energy savings relative to the comfort and energy savings that separate subsystems could provide alone. For example, integrated control layer 218 can be configured to use an input from a first subsystem to make an energy-saving control decision for a second subsystem. Results of these decisions can be communicated back to building subsystem integration layer 220.

Integrated control layer 218 is shown to be logically below demand response layer 214. Integrated control layer 218 can be configured to enhance the effectiveness of demand response layer 214 by enabling building subsystems 228 and their respective control loops to be controlled in coordination with demand response layer 214. This configuration can reduce disruptive demand response behavior relative to conventional systems. For example, integrated control layer 218 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 218 can be configured to provide feedback to demand response layer 214 so that demand response layer 214 checks that constraints (e.g., temperature, lighting levels, etc.) are properly maintained even while demanded load shedding is in progress. The constraints can also include setpoint or sensed boundaries relating to safety, equipment operating limits and performance, comfort, fire codes, electrical codes, energy codes, and the like. Integrated control layer 218 is also logically below fault detection and diagnostics layer 216 and automated measurement and validation layer 212. Integrated control layer 218 can be configured to provide calculated inputs (e.g., aggregations) to these higher levels based on outputs from more than one building subsystem.

Automated measurement and validation (AM&V) layer 212 can be configured to verify that control strategies commanded by integrated control layer 218 or demand response layer 214 are working properly (e.g., using data aggregated by AM&V layer 212, integrated control layer 218, building subsystem integration layer 220, FDD layer 216, or otherwise). The calculations made by AM&V layer 212 can be based on building system energy models and/or equipment models for individual BAS devices or subsystems. For example, AM&V layer 212 can compare a model-predicted output with an actual output from building subsystems 228 to determine an accuracy of the model.

Fault detection and diagnostics (FDD) layer 216 can be configured to provide on-going fault detection for building subsystems 228, building subsystem devices (i.e., building equipment), and control algorithms used by demand response layer 214 and integrated control layer 218. FDD layer 216 can receive data inputs from integrated control layer 218, directly from one or more building subsystems or devices, or from another data source. FDD layer 216 can automatically diagnose and respond to detected faults. The responses to detected or diagnosed faults can include providing an alarm message to a user, a maintenance scheduling system, or a control algorithm configured to attempt to repair the fault or to work-around the fault.

FDD layer 216 can be configured to output a specific identification of the faulty component or cause of the fault (e.g., loose damper linkage) using detailed subsystem inputs available at building subsystem integration layer 220. In other exemplary embodiments, FDD layer 216 is configured to provide “fault” events to integrated control layer 218 which executes control strategies and policies in response to the received fault events. According to an exemplary embodiment, FDD layer 216 (or a policy executed by an integrated control engine or business rules engine) can shut-down systems or direct control activities around faulty devices or systems to reduce energy waste, extend equipment life, or assure proper control response.

FDD layer 216 can be configured to store or access a variety of different system data stores (or data points for live data). FDD layer 216 can use some content of the data stores to identify faults at the equipment level (e.g., specific chiller, specific AHU, specific terminal unit, etc.) and other content to identify faults at component or subsystem levels. For example, building subsystems 228 can generate temporal (i.e., time-series) data indicating the performance of BAS 200 and the various components thereof. The data generated by building subsystems 228 can include measured or calculated values that exhibit statistical characteristics and provide information about how the corresponding system or process (e.g., a temperature control process, a flow control process, etc.) is performing in terms of error from its setpoint. These processes can be examined by FDD layer 216 to expose when the system begins to degrade in performance and alarm a user to repair the fault before it becomes more severe.

Referring now to FIG. 3, a system 300 including a school analysis system 304 that generates recommendations and reports for spaces of a school building 301 based on air quality measurements of sensors 302 is shown, according to an exemplary embodiment. A technician can install the sensors 302 in the school building 301 on a temporary basis, e.g., for one week, two weeks, a month, etc. The sensors 302 can be spread out through various spaces of the school building 301 in order to record air quality measurements of each space of the school building 301. The spaces of the school building 301 can be or include rooms, zones, offices, classrooms, hallways, gymnasiums, orchestra rooms, concert halls, etc. In some embodiments, the school building 301 can be an office building, a commercial building, an apartment building, a hospital, etc. The systems and methods discussed herein can be applied to various types of buildings and are not limited to school buildings.

Each sensor of the temporary air quality sensors 302 can measure one or multiple air quality metrics, e.g., can include one sensors or a set of sensors. For example, the sensors 302 can measure ventilation for a space, occupancy for a space, CO2 for a space, particulate matter PM10 for a space, particulate matter PM2.5 for a space, volatile organic compounds (VOC) for the space, TVOC for the space, thermal measurements for the space, temperature for the space, relative humidity for the space, dew point for the space, ozone for the space, carbon monoxide (CO) for the space, formaldehyde for the space, etc. In some embodiments, the sensors 302 are permanent sensors that are installed in a permanent manner. In this regard, if the sensors 302 are permanent, the reports and/or recommendations can be generated based on data collected by the sensors 302 over a requested period of time, e.g., a particular day, week, year, etc.

The sensors 302 can communicate the measurements made by the sensors 302 to the school analysis system 304 or a cloud platform that can perform an analysis on the air quality measurements of the various spaces of the school building 301. For example, the sensors 302 can be wireless sensors (or wired sensors) that communicate across a network 314 which may include local networks within the school building 301 and/or external networks. For example, various routers, switches, servers, cellular towers, LAN networks, WAN networks, Wi-Fi networks, Bluetooth communicating channels, 3G networks, 4G networks, 5G networks 6G, networks etc. can be included within the network 314 and can communicate the measurements of the sensors 302 to the school analysis system 304.

The temporary air quality sensors 302 can include processors, memory devices, processing circuits, network communication modules, or other components that can process the measurements collected by the temporary air quality sensors and communicate with a computing system and/or the school analysis system 304. The processing and memory devices can be the same as or similar to the processors 306 and the memory devices 308. The network communication module can be the same as or similar to the communications interface 207 or the BAS interface 409. The processing systems of the temporary air quality sensors 302 can communicate with cloud systems, computing systems, computing devices, data processing systems, server systems, or other components via the network 314. The temporary air quality sensors 302 can communicate measurements directly to the school analysis system 304 or to another computing system. The computing system can be separate from, integrated with, or the same as, the school analysis system 304. The computing system can be configured to connect to, activate, collect measurements from, disconnect, or deactivate the sensors 302. The computing system can communicate collected measurements of the sensors 302 to the school analysis system 304 for analysis and processing.

The computing system or the school analysis system 304 can be configured to connect with the sensors 302 at activate the sensors 302. The computing system or school analysis system 304 can transmit data, data packets, messages, commands, or other information to the sensors 302 to connect with the sensors 302. The sensors 302 can receive messages from the computing system or the school analysis system 304 that instantiate or initiate a communication channel or tunnel with the sensors 302. The sensors 302 can be configured to connect with the computing system or the school analysis system 304 responsive to receiving a message, data packet, or other piece of information from the computing system or the school analysis system 304. The computing system or the school analysis system 304 can activate the sensors 302. The sensors 302 can receive a command, message, or data packet that causes the sensors 302 to activate. The sensors 302 can activate responsive to receiving the data. The sensors 302 can activate by powering on, collecting sensor measurements, or transmitting the measurements to the computing system or the school analysis system 304. The computing system or the school analysis system 304 can disconnect from and/or deactivate the sensors 302. The computing system or the school analysis system 304 can transmit a message, data packet, or command to the sensors 302 that cause the sensors 302 to disconnect from communicating with the computing system or the school analysis system 304 or deactivate. The sensors 302 can be configured to disconnect from communicating with the computing system or the school analysis system 304 and/or deactivate by stopping collecting measurements, powering off, etc.

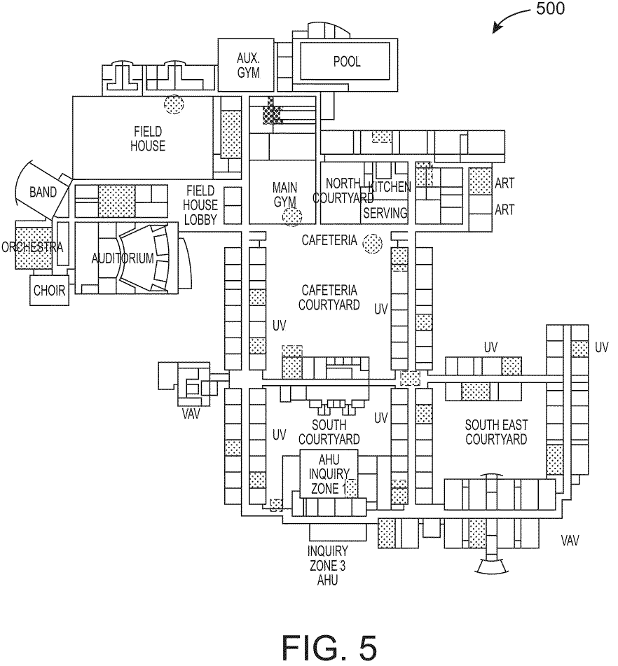

Furthermore, information describing physical characteristics of the school building 301 and various spaces of the school building 301 can be provided to the school analysis system 304 via a mobile application of a user device 312, a web browser of the user device 312, and/or any another application of the user device 312. The information can be manually collected site data, photos of the school building 301, equipment information of the school building 301, schematic diagrams or floor plans of the school building 301 (e.g., the schematics of FIGS. 5-8), user information, desired metrics from the sensors 302, desired school performance indications, floor plans of the spaces assessed via the sensors 302, AHU zone maps indicating each AHU and the spaces the AHUs serve, an AHU list/schedule indicating lists of AHUs with sizes and service information, etc. The user device 312 can be a smartphone, a tablet, a laptop computer, a desktop computer, etc. The user device 312 can communicate with the school analysis system 304 via the network 314.

The school analysis system 304 can be a cloud based system, a remote system, a local on-premises system with the school building 301, a distributed processing system, or any other kind of computing system. The school analysis system 304 can include one or multiple processors 306 and/or one or multiple memory devices 308. Processors 306 can be implemented as a general purpose processor, an application specific integrated circuit (ASIC), one or more field programmable gate arrays (FPGAs), a group of processing components, processing circuits, or other suitable electronic processing components.

Memory devices 308 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory devices 308 can be or include volatile memory or non-volatile memory. Memory devices 308 can include database components, object code components, script components, or any other type of information structure for supporting the various activities and information structures described in the present application. In some embodiments, the memory devices 308 are communicably connected to the processors 306 via and the memory devices 308 include computer code for executing (e.g., by the processors 306) one or more processes described herein.

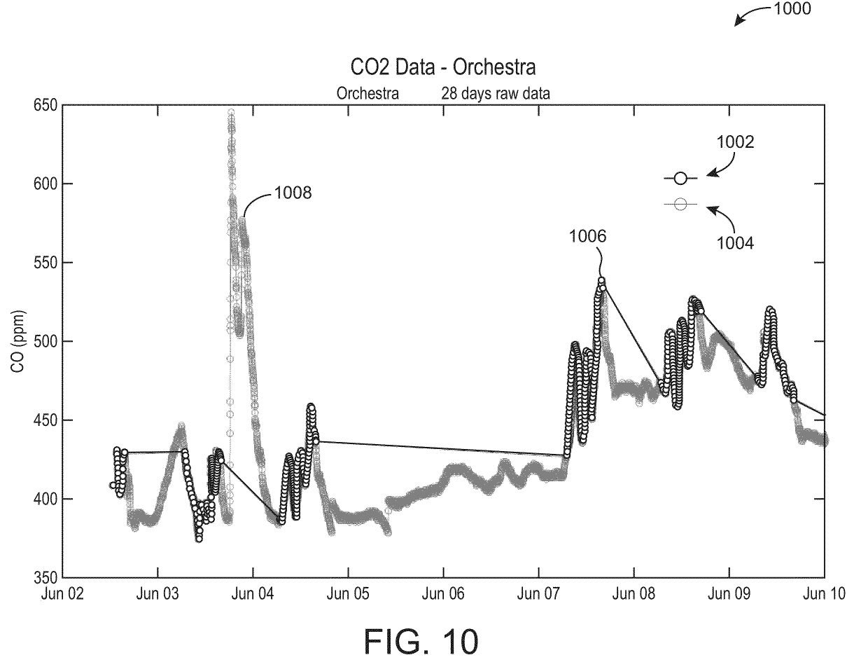

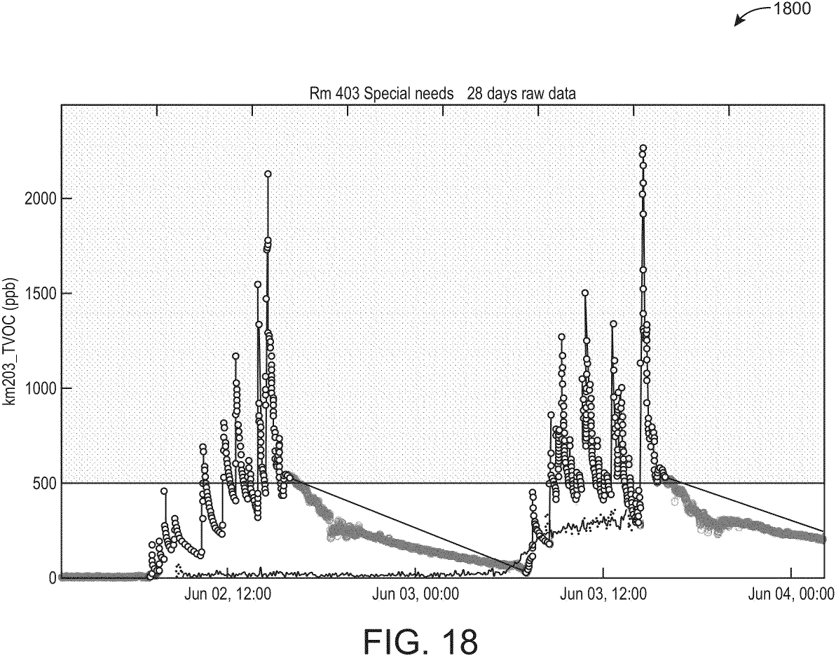

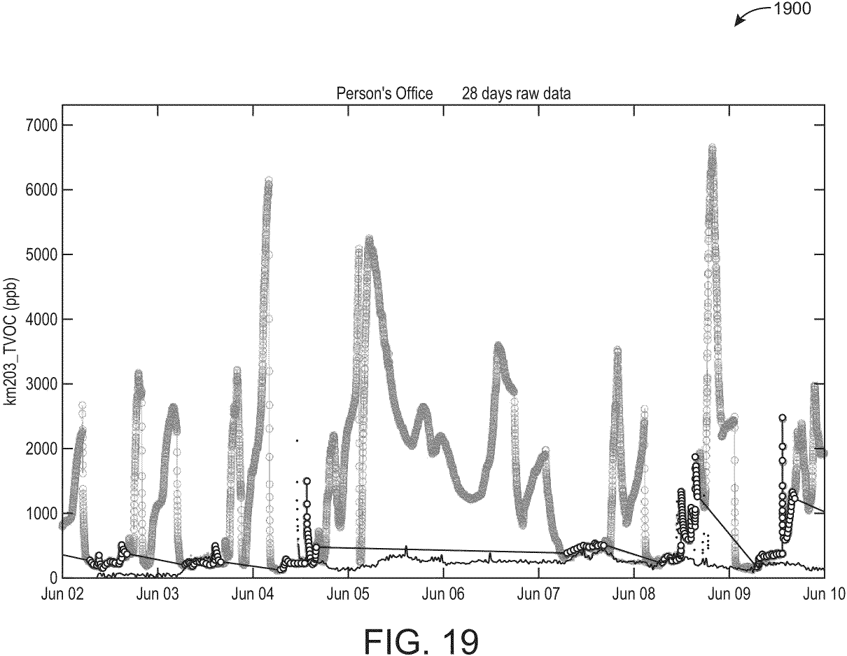

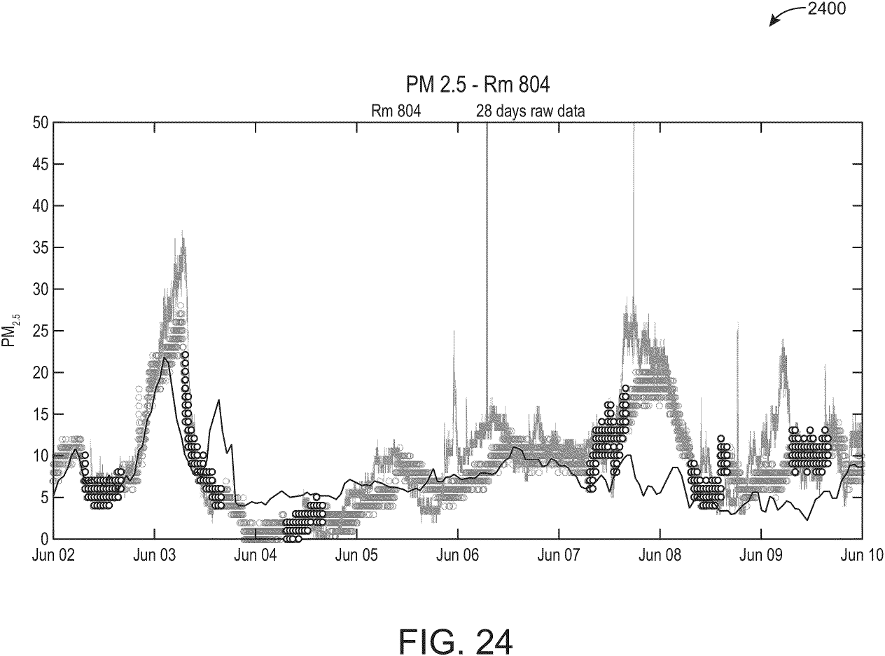

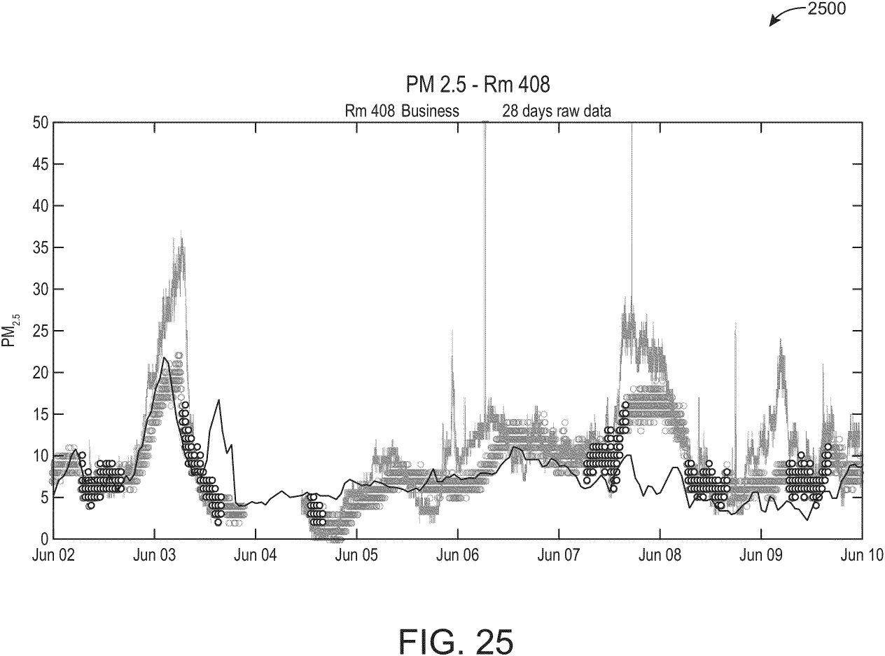

The school analysis system 304 can include a space air quality analyzer 311, a recommendation generator 307, and a report generator 310. The space air quality analyzer 311 can record measurements of the various sensors 302 and create air quality profiles of the various spaces of the school building 301. For example, the analyzer 311 can record air quality for the spaces and generate a trend over time (e.g., timeseries data or other time correlated data) in which the temporary sensors 302 are installed, e.g., over the two weeks that the sensors 302 are installed. The trends created by the analyzer 311 can be the trends shown in FIGS. 10-12, FIGS. 17-19, and FIGS. 22-25. The trends created by the analyzer 311 can be provided to the recommendation generator 307 and the report generator 310.

In some embodiments, the analyzer 311 can generate space hierarchy air quality information. For example, rooms, hallways, and closets may be basic units of space in the school building 301. However, a hierarchy of spaces can be built from the basic space unit. For example, a group of rooms could form a zone of a floor. A group of zones could form a floor of a building. A group of floors could form a building of a campus. The analyzer 311 can generate low level space air quality metrics for basic space units. The analyzer 311 can generate higher level space air quality metrics for a particular space based on the basic space units that make up the particular space. For example, a CO2 metric for a floor could be generated by averaging the CO2 metrics for all rooms that make up the floor. Similarly, the CO2 metrics for a building could be made based on averaging CO2 metrics for all the floors of the building. In some embodiments, the metrics may be used to generate space health scores for the spaces (e.g., the rooms themselves, floors/buildings/campuses that include the rooms, etc.). In some embodiments, the space health scores may be specific to air quality. In some embodiments, the metrics may be used in combination with other metrics to generate an overall space health score. In some embodiments, the air quality metrics may be used in combination to generate a combined air quality health score, and that score may in turn be used as a component score to generate an overall space/building health score that includes air quality as a component. Example of such features that can be used in conjunction with the features of the present disclosure can be found in U.S. Pat. Application Nos. 17/354,583, filed Jun. 22, 2021, and 17/354,565, filed Jun. 22, 2021, both of which are incorporated herein by reference in their entireties.

The report generator 310 can generate reports that summarize the air quality trends of the spaces of the building and/or include recommendations. For example, the charts and tables shown herein can be generated by the report generator 310 and included within a report generated by the report generator 310. The report generated by the report generator can provide the report to the user device 312 for review by a user. The report can further indicate areas of the school building 301, recommendations for improving indoor air quality (IAQ) (e.g., reduce particular levels, reduce TVOCs to be below a particular threshold, etc.), recommendations for saving energy in the school building 301 (e.g., reduce energy consumption of the school building 301 to be less than a threshold), etc. In some embodiments, the report is a user interface including various charts, graphs, trends, recommendations, or other information. The interface can be displayed on a display device of the user device 312.

The report generator 310 can generate a report including recommendations generated by the recommendation generator 307 indicating actionable data that can be implemented by the system 304 and/or a BMS system of the school building (e.g., the BMS system described in FIGS. 1-2). The recommendations can indicate a recommendation to improve ventilation in a room of the school building 301 that requires additional ventilation (e.g., operate ventilation equipment to increase a ventilation rate), can recommend opportunities for energy savings where adjusting ventilation when a space is unoccupied would save energy (e.g., operate ventilation equipment to decrease a ventilation rate), recommendations which identify equipment which could provide better ventilation and/or filtering for spaces (e.g., install VAVs or unit ventilators (UVs) based on which type of equipment is performing better), assessments of adequacy of outdoor air filtration, recommendation to filter mixed air, etc. The report generator 310 can include a summary indicating key findings, testing details, testing results, photographs, conclusions, recommendations, etc.

The report generated by the report generator 310 can include a detailed building data summary report that indicates building size and use, recent renovation, special use areas, number of AHU’s, filtration type and schedule, air supply system type, and specific areas of concern. The report can indicate a technicians visual inspection of representative AHU’s, fan coil units, induction units, filter type/installation/condition, air supply diffusers, exhaust systems, and/or return air grilles. The report can indicate whether air systems of the school building 301 are under proper control, a sequence of operations is being followed, and all controls are operating per the desired setpoint and schedule.

The report can include air quality tests of the sensors 302, e.g., CO2, CO, PM2.5, temperature, relative humidity, NO2, SO2, O3, VOC’s, airflow vectors, air pressure differentials, etc. The report can indicate a ventilation assessment indicating the results of testing that ensures outside air intake, supply air fan, and/or ventilation system is supplying minimum outdoor air ventilation rate detailed by ASHRAE 62.1-2016. Ventilation needs based on space type, square footage, and occupancy. The report can indicate an infection risk assessment indicating DNA-tagged bioaerosolstracers safely simulate respiratory emissions to identify potential infection hotspots, verify ventilation and filtration system performance for mitigating airborne exposures, and optimize enhancements.

The recommendations generated by the recommendation generator 307 and included within the report generated by the report generator 310 can further include recommendations to investigate ventilation rates of rooms of the school building 301 with CO2 levels above a particular level (e.g., 1100 ppm). The recommendations can indicate a current ventilation rate of a space along with comparisons to other ventilation rates of other spaces, inconsistencies can indicate that a user should consider adjusting the ventilation rates of the spaces. If all of the ventilation rates are similar, the recommendation can recommend changing a ventilation policy for the entire school building 301. The recommendations could further be to analyze a source of TVOC for a space where TVOC is above a particular amount, investigate a source of VOCs in a space with TVOCs above a particular amount, etc.

The recommendations, in some embodiments, can include recommendations to improve ventilation, e.g., diluting dirty air with clean air as available from outside the school building 301. This recommendation can ensure the delivery of ASHRAE required ventilation rates. The recommendations can be recommendations to improve filtration for spaces. Filtration may mechanically remove particles from the air of the space. The recommendation can be a recommendation to increase particle collection with options with filters such as Koch filters, MAC-10 fan filter units, enviro portable HEPA filtration units, etc.

The recommendations can include recommendations for improving disinfection for a space, e.g., deactivating bacteria and/or viruses in the space. The recommendations can be recommendations to install and/or operate disinfectant systems such as disinfectant light systems (e.g., ultraviolet (UV), ultraviolet-C (UVC), etc.). The recommendations can be recommendations to implement isolation of certain spaces of the school building 301. The isolation can be achieved by locking or unlocking various doors of the school building 301 to limit access of occupants of the school building 301 to an isolated space. For example, cause one space to be an isolated space that contains particles and prevents the particles going elsewhere in the school building 301. This can be implemented through creating a negative-pressure isolation environments. The recommendations can be recommendations for performing monitoring and maintenance of equipment, e.g., to inspect equipment at a particular frequently and/or track results for maintenance and monitoring to maintain clean air.

In some embodiments, the CO2 measurements of the sensors 302 can be used by the recommendation generator 307 to determine how well a space is being ventilated. If the CO2 levels are higher than particular amounts, a recommendation to increase ventilation can be generated and/or implemented. The TVOC measurements can indicate how safe a space is for human beings and/or animals. If TVOC is above a particular level, an alert can be generated to evacuate the space and/or address the high TVOC level. The PM2.5 levels can indicate how well filtering equipment is operating. If PM2.5 is greater than a particular amount, this may indicate that the space is not being properly filtered and that a filter of equipment serving the space needs to be replaced and/or changed to a higher quality filter.

In some embodiments, the recommendation generator 307 can perform an analysis on equipment type for the spaces. For example, the generator 307 could analyze that spaces with low PM2.5 use unit ventilators while spaces with high PM2.5 use VAVs. This improvement in performance of the unit ventilators vs. the VAVs can be used in a recommendation for the recommendation generator 307 to recommend that unit ventilators replace the VAVS in the school building 301.

In some embodiments, the recommendation generator 307 could recommend that persons with allergies be assigned to areas of a building with low VOC, TVOC, PM2.5, and/or PM10 levels. This may allow the allergenic persons to avoid having an asthma attack or other breathing problems. In some embodiments, class scheduling can be set up and/or recommended by the school analysis system 304 such that students or teachers are not assigned spaces with high VOC, TVOC, PM2.5 levels for a long duration.

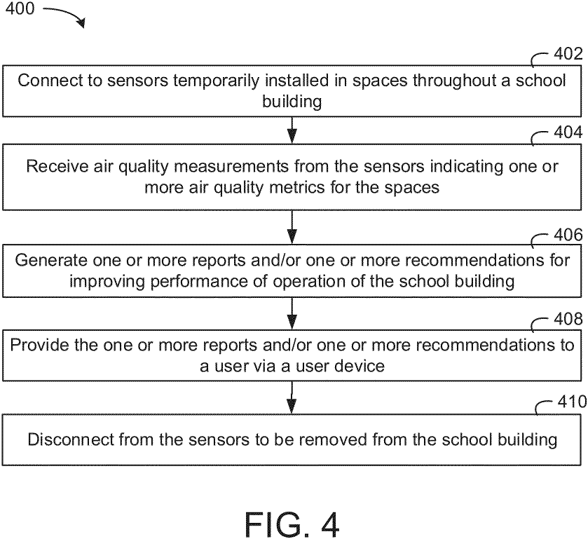

Referring now to FIG. 4, a process 400 where temporary air quality sensors are installed in spaces of a school building to collect air quality measurements of the spaces and generate one or more reports and/or recommendations is shown, according to an exemplary embodiment. The process 400 can be performed by the school analysis system 304. Furthermore, the process 400 can be performed by any computing device described herein.

In step 402, the school analysis system 304 can connect to the temporary air quality sensors 302 via the network 314, the temporary air quality sensors 302 being installed by a technician in the school building 301 on a temporary basis (e.g., for two weeks, three weeks, etc.). Connecting to the sensors 302 can include sending a message to the sensors 302 requesting a response, receiving an indication from the sensors 302 indicating that the sensors 302 are online, receiving measurements from the sensors 302 for a first time, creating a data point to store measurements of the sensor in, etc. In step 404, the air quality measurements can be received by the school analysis system 304 from the sensors 302. The sensors 302 can stream air quality measurements from the sensors 302 to the school analysis system 304. The sensors 302 can perform a periodic or single bulk upload of air quality measurements collected and stored by the sensors 302. Each sensor measurement can be associated with a timestamp. The sensor data communicated by the sensors 302 to the school analysis system 304 can be timeseries data, event series data, or other time correlated data.

In step 406, the school analysis system 304 can generate one or more reports and/or recommendations for improving performance of operation of the school building 301. The reports can summarize air quality for various spaces of the school building 301, e.g., the charts and graphs shown herein. The recommendations can be included within the reports and can indicate control operations for implementation for various spaces (e.g., new ventilation rates, air flow rates, air change rates, etc.). The recommendations can recommend investigation into various sources of TVOCs, VOCs, etc. in various paces of the school building 301, etc. The one or more reports and/or recommendations can be provided to a user for review via the user device 312 in step 408.

In some embodiments, the report can include infection risk for the school building 301, spaces of the school building 301, students of the school building 301, and/or staff of the school building 301. The infection risk can be a risk level of contracting an infectious disease present in a population (e.g., COVID19, influenza, the bird influenza, etc.). The infection risk can be based on current ventilation rates, filter performance, etc. which can be derived from the air quality measurements of the sensors 302. The report can indicate a control profile or control strategy, e.g., guidelines, instructions, or settings for implementing physical control of AHUs, VAVs, unit ventilators, temporary space filters, etc. The control profile may include ranges for operating settings, recommended operating settings, specific control algorithms to be used, etc. This control profile can operate equipment to reduce the infection risk. In some embodiments, the control profile can operate to provide energy savings. The control profile can be used to determine operating settings that are implemented at a time after the sensors 302 are disconnected from and/or uninstalled. In some embodiments, features described in U.S. Pat. Application Nos. 16/927,759 and 16/927,318, both filed Jul. 13, 2020 and both incorporated by reference herein in their entireties, can be utilized in conjunction with the features of the present disclosure. For example, in some embodiments, the infection risk can be estimated using the readings collected by the sensors and processed using the Wells-Reilly equation as described in detail in the aforementioned applications.

In step 410, the school analysis system 304 can disconnect from the sensors 302 as the sensors 302 are to be removed and uninstalled by a technician. Disconnecting from the sensors 302 can include sending a shutdown message to the sensor 302, sending a disconnect message from the sensors 302, not receiving new data from the sensors 302, etc. The sensors 302 can be uninstalled by the technician and disconnected from at the end of the temporary installation period. After the sensors are disconnected from, a BMS system can begin operating with operating settings and/or control algorithms based on the control profile generated by the school analysis system 304. The school analysis system 304 can communicate the control profile as an update to the BMS and cause the BMS to install and run the control profile. A user, via a user device, may review the control profile and approve the control profile to run on the BMS. Implementing the control profile can cause various environmental conditions of the building to be controlled by equipment of the building via signals, data parameters, data packets, control commands, etc. which can be based on the control profile.

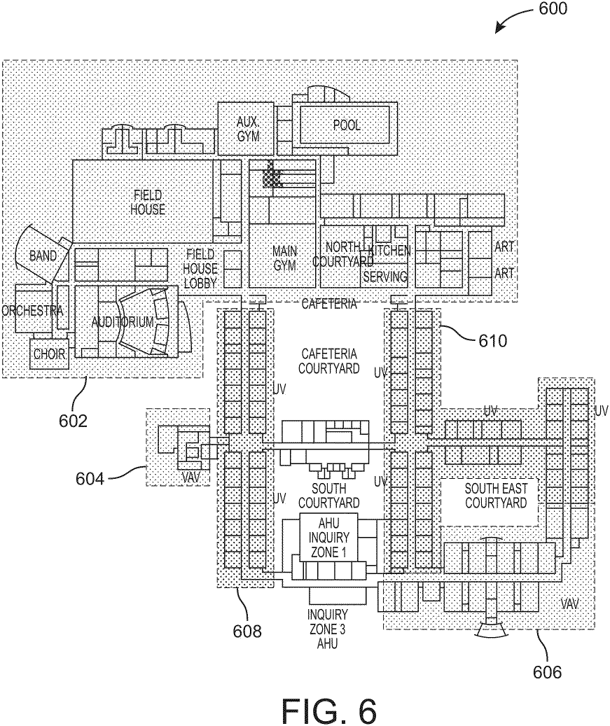

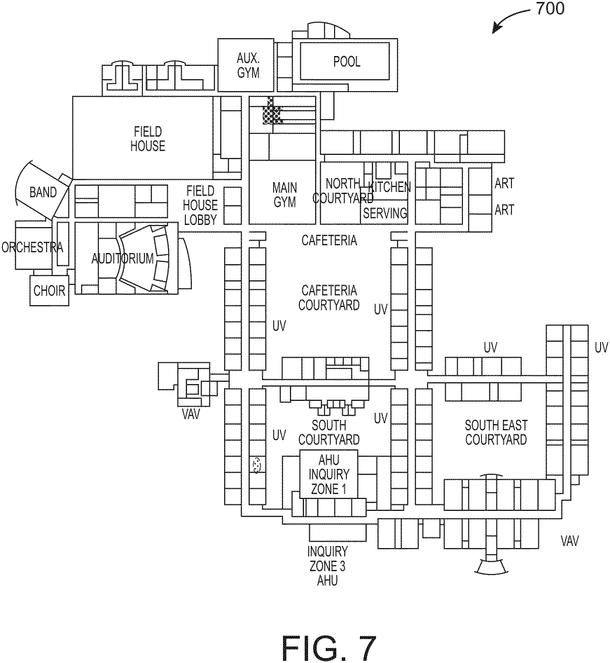

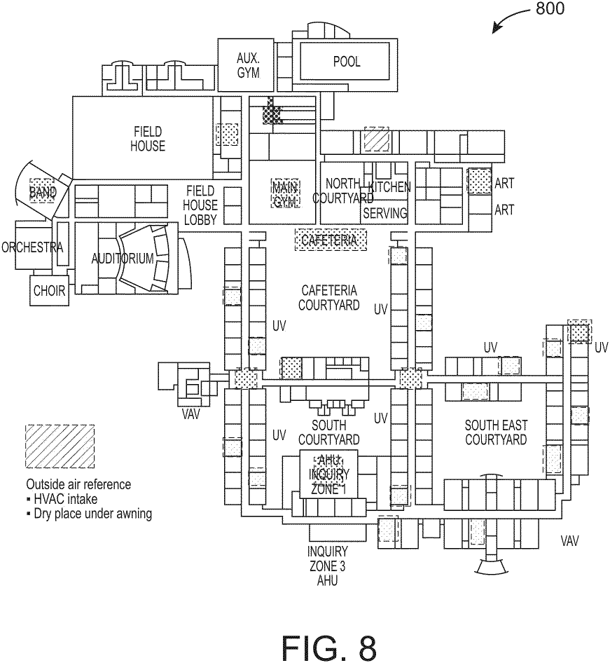

Referring now to FIGS. 5-8 schematic diagrams 500-800 of spaces of the school building 301 and equipment of the school building are shown, according to an exemplary embodiment. The schematic diagrams 500-800 can be used by the school analysis system 304 to generate recommendations and/or reports. For example, indications of various spaces, locations of sensors, locations of equipment, etc. can be used to determine which pieces of equipment should operate differently to improve air quality in various spaces of the school building 301. FIG. 5 indicates spaces of the school building 301 with sensors. FIG. 6 indicates spaces 602-606 that have VAVs while spaces 608-610 that include unit ventilators. FIG. 7 indicates a special area of the school building 301 that may require attention and/or investigation because of poor air quality. FIG. 8 indicates outside air reference, HVAC intake, and a dry place under an awning.

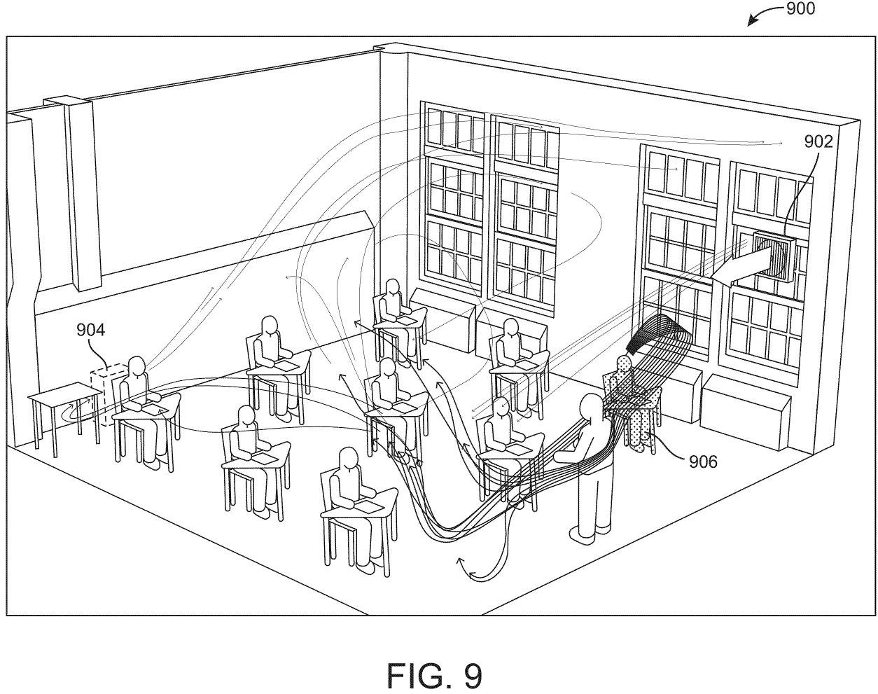

Referring now to FIG. 9, a schematic diagram of a space 900 of the school building 301 including a fan 902, an air cleaner 904, and an infected student 906 is shown, according to an exemplary embodiment. Proper IAQ can be critical to mitigating the risk of transmitting airborne viruses like COVID19, the COVID19 delta variant, COVID2x, influenza, etc. Furthermore, proper IAQ can reduce absenteeism of school from allergies and/or asthmatic reactions. IAQ is further linked to improved cognitive ability, e.g., employee test scores and/or employee productivity.

The air quality assessment processes described herein can help to improve IAQ, improve ventilation, and improve the operation of infection control systems through real world testing and verification. The assessment process can enhance safety from infectious diseases and improve financial decision making (e.g., save the school building 301 money by reducing energy consumption of the building). The process can prevent misdirected efforts and wasted spending. The process can enable short term and long term value creation. The process can generate an independent, science based, defensible assessment reducing owner liability.

Referring now to FIGS. 10-12, charts 1000-1200 of CO2 levels over a time period for various spaces of the school building 301 is shown, according to an exemplary embodiment. The charts 1000-1200 indicates CO2 levels measured by the sensors 302 for a week, e.g., from June 2^{nd} to June 10^{th} for a particular year. The trends 1004, 1104, and 1204 and measurements of the charts 1000-1200 indicate CO2 levels outside school hours. The trends 1002, 1102, and 1202 and measurements of the charts 1000-1200 indicate CO2 levels inside school hours. The school hours may be defined as Monday through Friday, 7 AM to 3 PM.

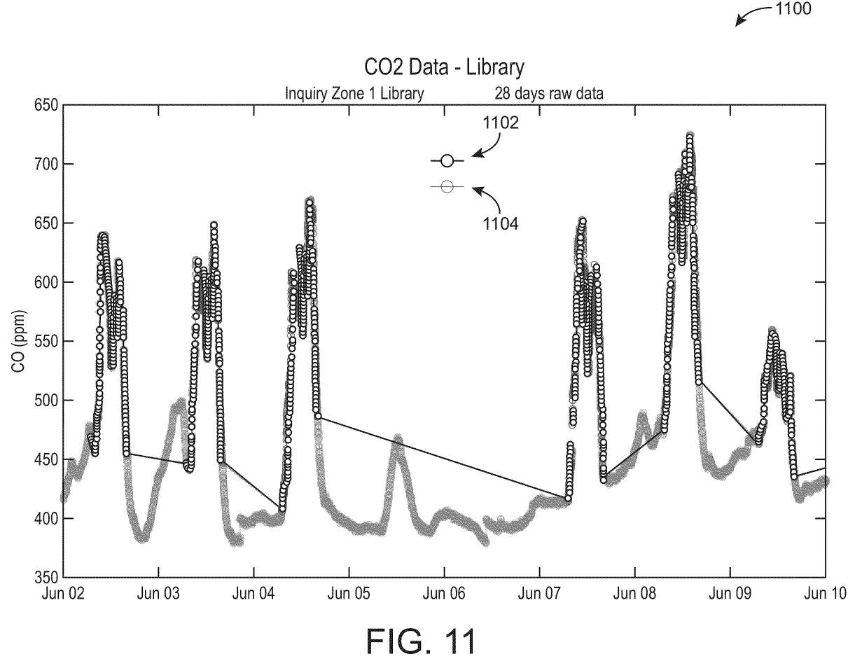

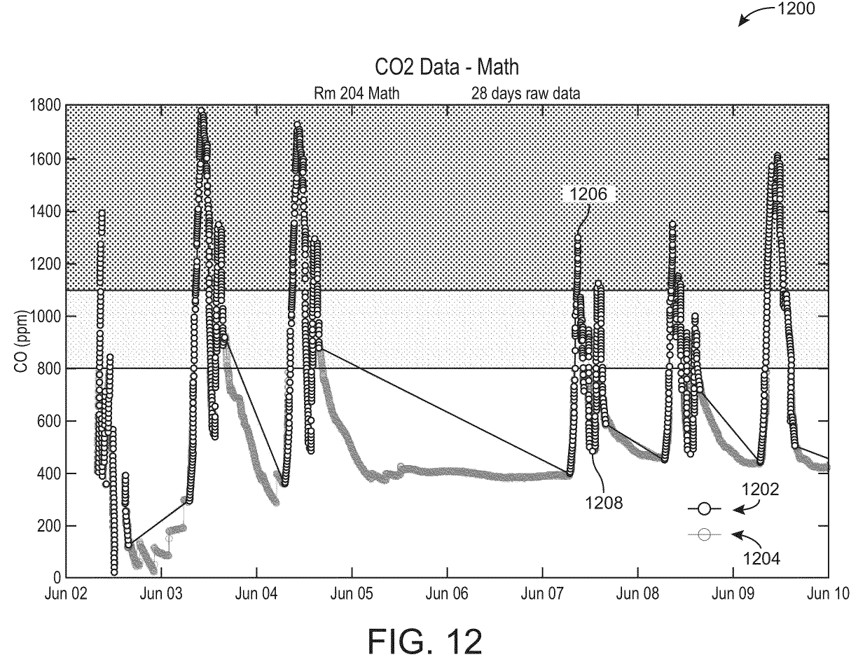

FIG. 10 is a chart 1000 of CO2 of an orchestra of a library of the school building. Marker 1008 indicates an increase in CO2 levels for the orchestra during an evening orchestra practice session. Marker 1006 indicates generally low CO2 levels. FIG. 11 is a chart 1100 of CO2 of a zone of a library of the school building. FIG. 12 is a chart 1200 of CO2 for a math room of the school building. Marker 1206 indicates that CO2 levels are high indicating high occupancy and/or low ventilation. Marker 1208 indicates a variation in levels indicating changes in occupancy, smaller class size, vacant class size, etc.

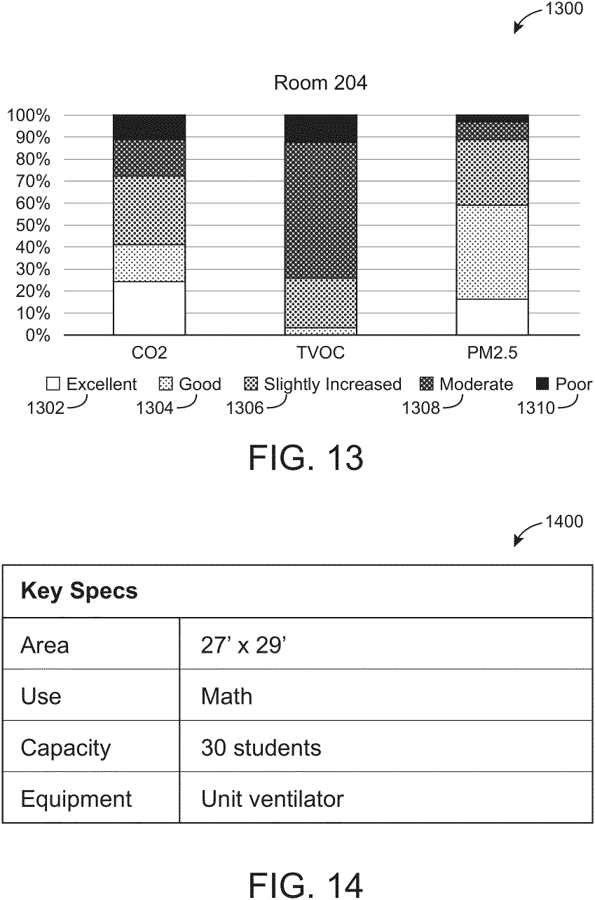

Referring now to FIG. 13, a chart 1300 of CO2, TVOC, and PM2.5 for the math room of FIG. 10 is shown, according to an exemplary embodiment. The chart 1300 indicates percentages of time of a duration that the CO2, TVOC, and PM2.5 were in particular ranges for the math room. The duration may be the time period that the sensors 302 were installed in the school building 301. For example, the CO2 bar indicates what percentage of time the CO2 levels of the math room were in various ranges, e.g., an excellent range 1302, a good range 1304, a slightly increased range 1306, a moderate range 1308, and poor range 1310. The ranges can be color coded, green, light green, white, yellow, and red. Similar bars indicate percentages of time that TVOC and PM2.5 were in various ranges.

Referring now to FIG. 14, a table 1400 of specifications for the math room of FIG. 12 is shown, according to an exemplary embodiment. The table 1400 indicates an area of the math room, a use of the math room, a capacity of the math room, and equipment of the math room. The school analysis system 304 can generate recommendations for improving the performance of the math room, e.g., equipment settings, cleaning, analysis, etc. based on the data of the table 1400, the chart 1300 of FIG. 13, and/or the chart 1200 of FIG. 12.

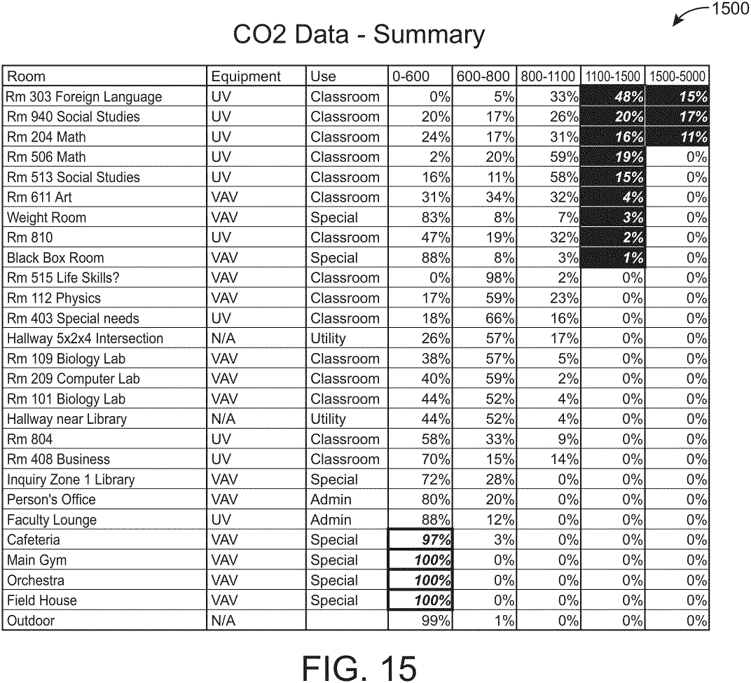

Referring now to FIG. 15, a summary table 1500 of CO2 measurements for spaces of the school building 301 is shown, according to an exemplary embodiment. The summary table 1500 indicates a percentage of time of a duration that each of the spaces had CO2 measurements in various ranges. The CO2 levels shown in the table 1500 can be occupied hours, e.g., school hours Monday through Friday 7 AM through 3 PM. The levels may be 0-600 ppm, 600-800 ppm, 1100-1500 ppm, and/or 1500-5000 ppm. The table 1500 can indicate temporal information for each space, e.g., the percentage of time in each range. Furthermore, the table 1500 can provide a peer comparison, e.g., a comparison of spaces against each other, the equipment of each space, and/or the user of each space.

In some embodiments, per a certain regulation (e.g., California regulation AB 841), CO2 levels at 1100 ppm should generate an alarm. CO2 levels above 1100 ppm could require immediate attention. CO2 levels at 800 ppm should trigger a setpoint for demand controlled ventilation. CO2 levels between 800 ppm and 1100 ppm may be a high normal range. CO2 levels between 600 ppm-800ppm may indicate a low normal range. CO2 levels below 600 ppm may be low and indicate an opportunity for energy savings.

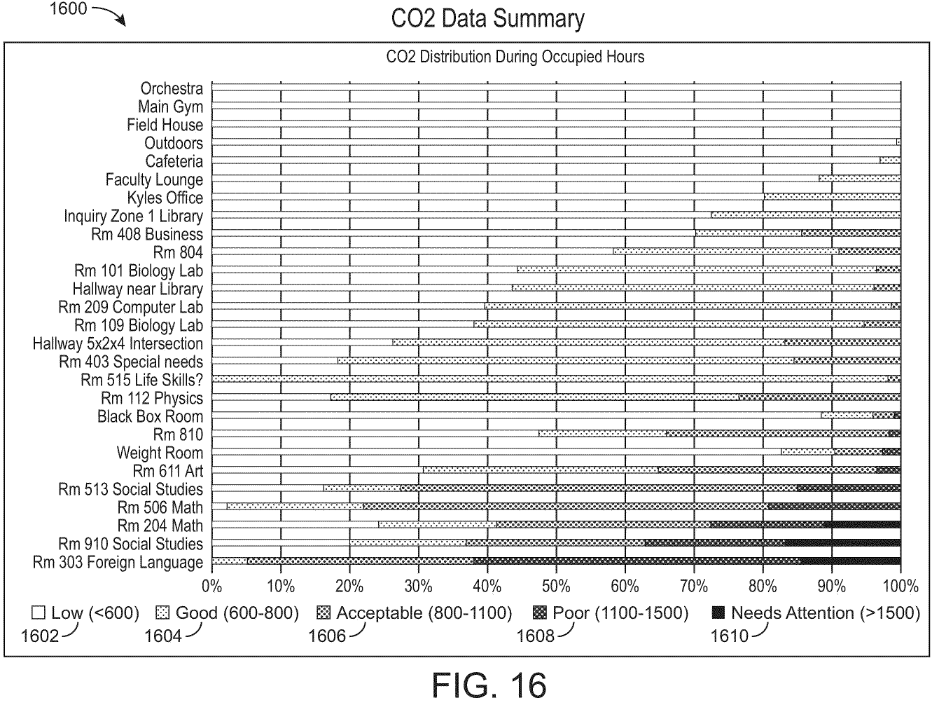

Referring now to FIG. 16, a chart 1600 of CO2 measurements for spaces of the school building 301 is shown, the chart 1600 indicating a percentage of time of a duration that each of the spaces had CO2 measurements in various ranges, according to an exemplary embodiment. The chart 1600 compares the CO2 levels of various spaces with a bars. The bars are divided up into components or sub-bars that are represented in various colors, patterns, or fills, the colors, patterns, or fills can indicate value ranges of CO2. The amount of each color, pattern, or fill for each bar indicates the percentage of time that the CO2 level for the particular space is in a particular range. The components 1602 (e.g., blue) indicate a low CO2 level, e.g., less than 600 ppm. The components 1604 (e.g., green) indicate a good range of CO2 levels, e.g., from 600 ppm to 800 ppm. The components 1606 (e.g., light green) indicate an acceptable range of CO2 levels, e.g., 800 ppm to 1100 ppm. The components 1608 (e.g., orange) and the components 1610 (e.g., red) indicate that the areas require attention. The components 1608 indicates CO2 levels in a range from 1100 ppm to 1500 ppm. The components 1610 indicates CO2 levels in a range greater than 1500 ppm.

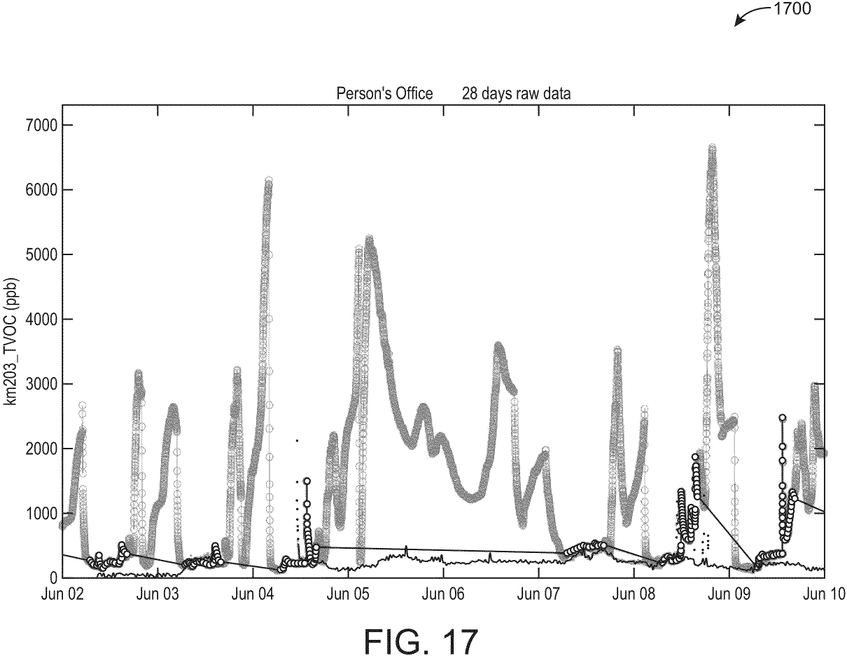

Referring now to FIGS. 17-19, charts 1700-1900 of TVOC levels over a time period for various spaces of the school building 301 is shown, according to an exemplary embodiment. The chart 1700 indicates TVOC for an office of the school building. In chart 1700 there are very high TVOC levels during unoccupied periods. This may be due to a source of TVOCs in the room. The chart 1800 indicates TVOC for a room 403 of the school building. The chart 1800 includes spikes in TVOCs at periodic intervals. This can indicate a TVOC source turning on and/or off, potentially a printer, coffee maker, fan, or other piece of equipment. The chart 1900 indicating TVOC measurements for an office of the school building, according to an exemplary embodiment.

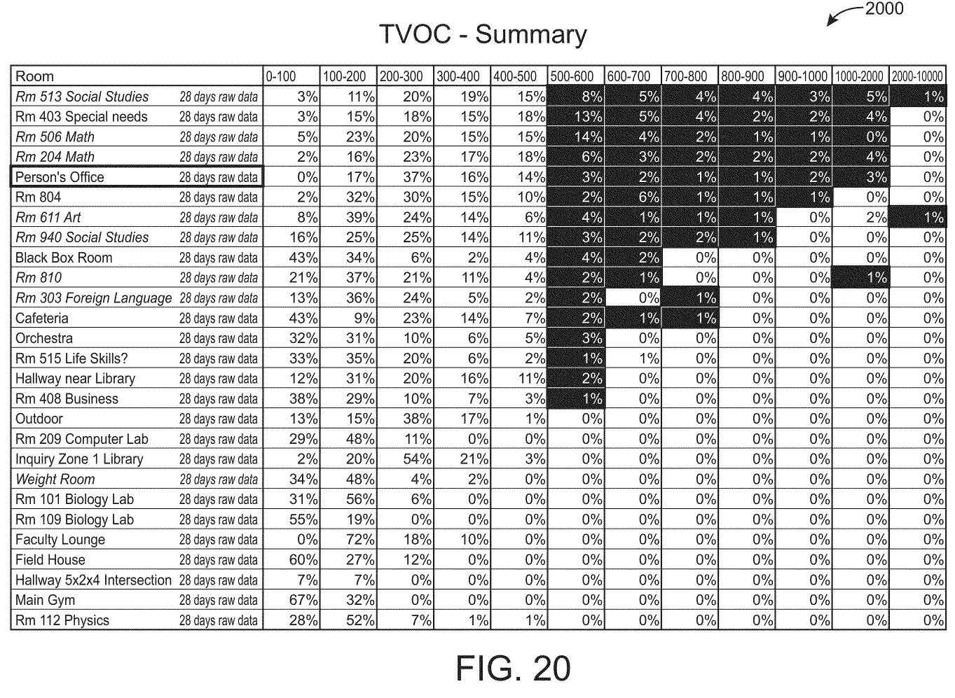

Referring now to FIG. 20, a summary table 2000 of TVOC measurements for spaces of a school building is shown, the summary table 2000 indicating a percentage of time of a duration that each of the spaces had TVOC measurements in various ranges. The summary table 2000 indicates a percentage of time of a duration that each of the spaces had TVOC measurements in various ranges.

The TVOC levels shown in the table 2000 can be for occupied hours, e.g., school hours Monday through Friday 7 AM through 3 PM. The levels may be 0-100 ug/m3, 100-200 ug/m3, 200-300 ug/m3, 400-500 ug/m3, 500-600 ug/m3, 600-700 ug/m3, 700-800 ug/m3, 800-900 ug/m3, 900-1000 ug/m3, 1000-2000 ug/m3, and 2000-10000 ug/m3. The table 2000 can indicate temporal information for each space, e.g., the percentage of time in each range. Furthermore, the table 2000 can provide a peer comparison, e.g., a comparison of spaces against each other. Recommended TVOC levels may be below 500 ug/m3 The blue rooms can indicate rooms with CO2>1100 ppm.

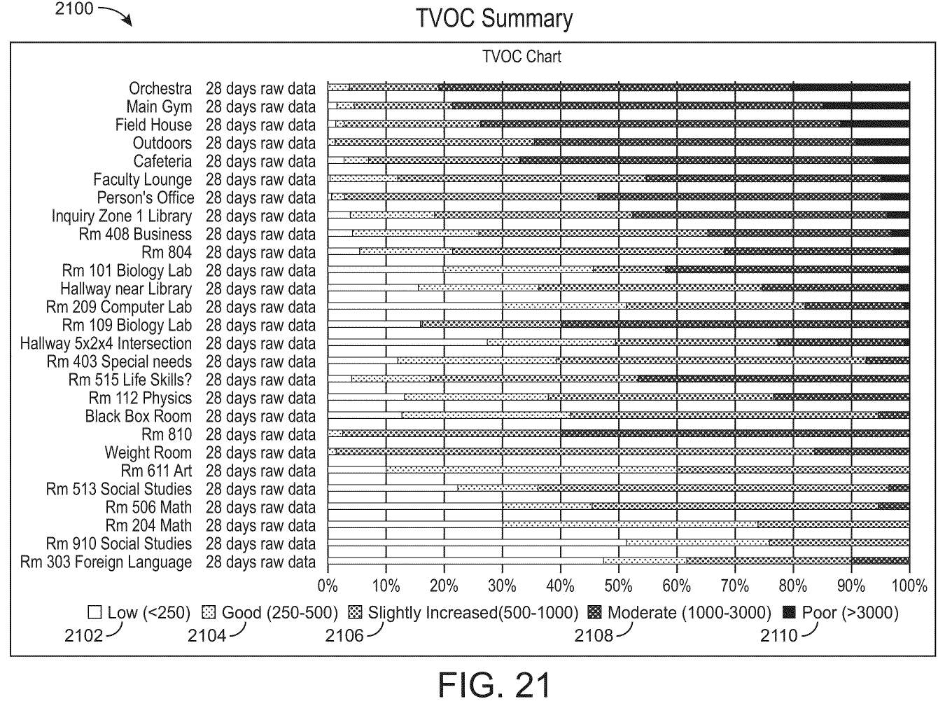

FIG. 21 is a chart of TVOC measurements for spaces of a school building, the chart indicating a percentage of time of a duration that each of the spaces had TVOC measurements in various ranges, according to an exemplary embodiment. The chart 2100 compares the TVOC levels of various spaces with a bars.

The bars can be divided up into various components or sub-bars indicated in a particular pattern or colors, the patterns or colors indicating ranges of TVOC. The amount of each color for each bar indicates the percentage of time that the TVOC level for the particular space is in a particular range. The first components 2102 (e.g., blue) can indicate an excellent TVOC level, e.g., less than 250 ug/m3. The second components 2104 (e.g., green) can indicate a good range of TVOC levels, e.g., from 250 ug/m3 to 500 ug/m3. The third components 2106 (e.g., light green) can indicate a slightly range of TVOC levels, e.g., 500 ug/m3 to 1000 ug/m3. The fourth components 2108 (e.g., orange) can indicate moderate TVOC levels in a range from 1000 ug/m3 to 3000 ug/m3. The fifth components 2110 (e.g., red) indicate poor TVOC levels in a range greater than 3000 ug/m3.

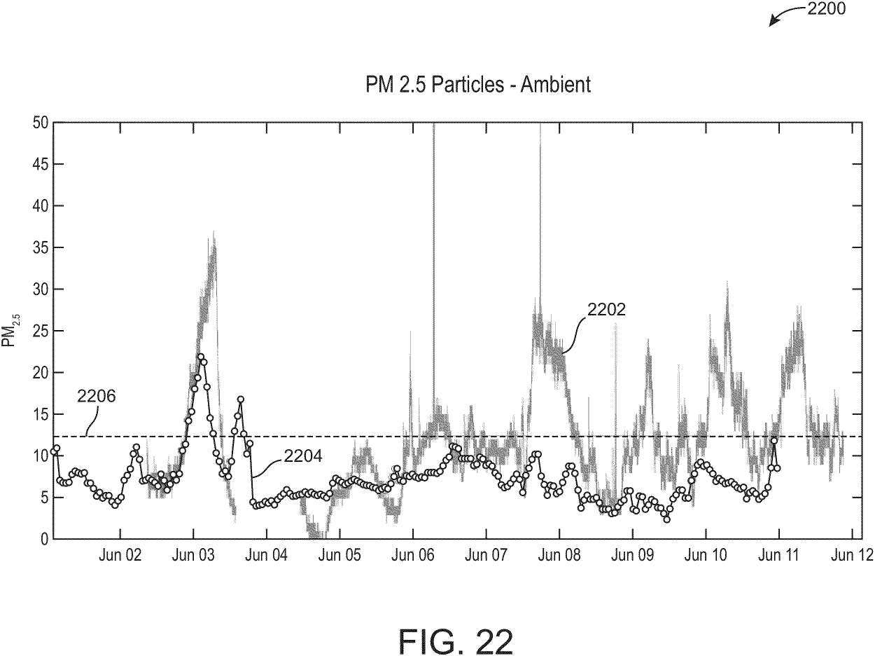

Referring now to FIG. 22, a chart 2200 of outdoor PM2.5 and indoor PM2.5 of a school building is shown, according to an exemplary embodiment. The chart 2200 illustrates outdoor PM2.5 particulate on a trend 2202 and indoor PM2.5 of the school building 301 particulate on a trend 2204. As can be seen, spikes in outdoor PM2.5 can cause spikes in indoor PM2.5. The horizontal line 2206 indicates a long term exposure limit indicating a level at which occupants should be exposed to at an extended duration.

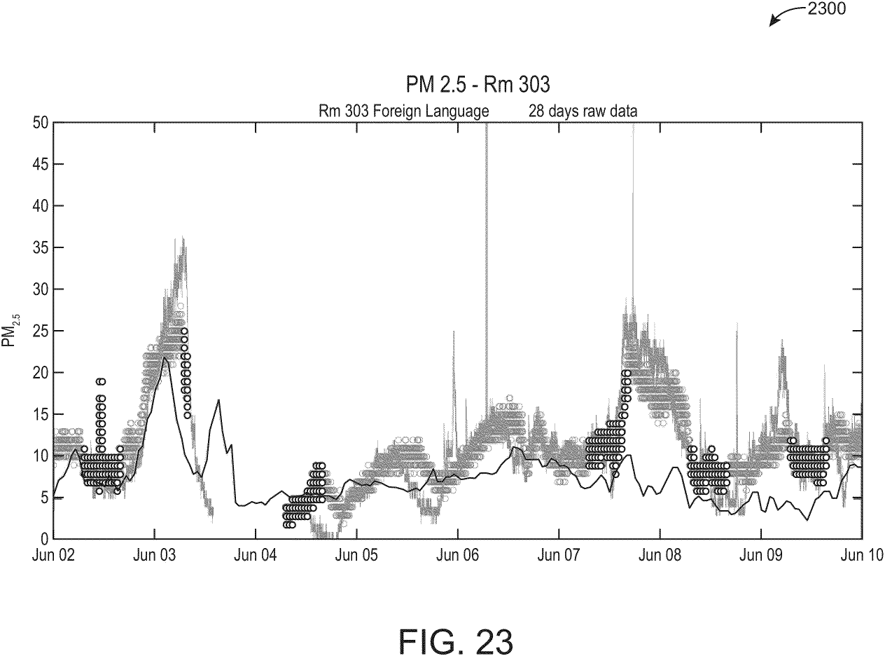

Referring now to FIGS. 23-25, charts 2300-2500 of PM2.5 particulate over a time period for various spaces of the school building 301 is shown, according to an exemplary embodiment. The PM2.5 particulate levels of the various spaces of the charts 2300-2500 can be measured by the sensors 302, in some embodiments. The chart 2300 indicates PM2.5 particulate for a room 303 of the school building 301. The chart 2400 indicates PM2.5 particulate of a room 804 of the school building 301. The chart 2500 indicates PM2.5 particulate of a room 408 of the school building 301.

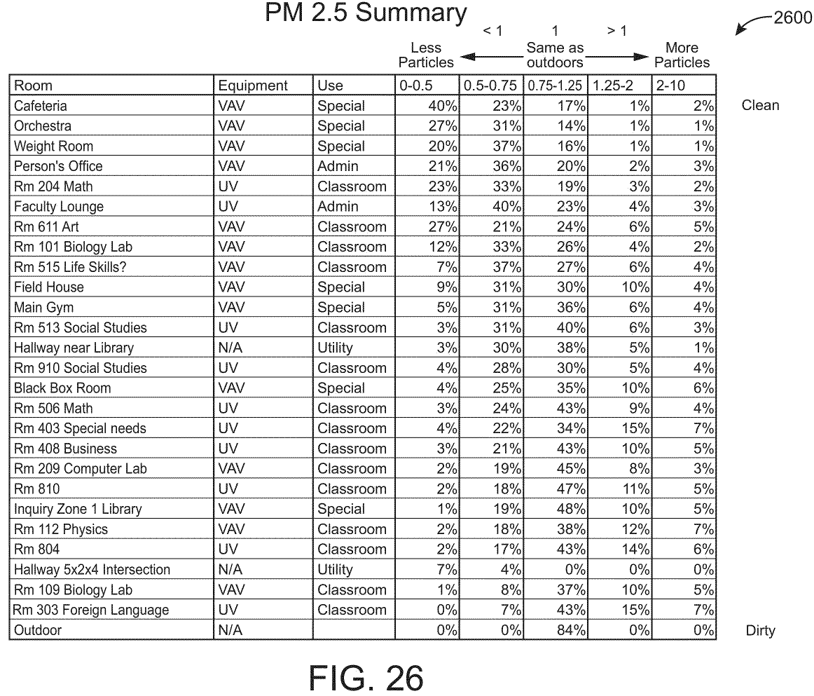

Referring now to FIG. 26, a summary table 2600 of PM2.5 particulate for various spaces of the building indicating percentages of time that a ratio of indoor PM2.5 particulate to outdoor PM2.5 particulate is in particular ranges is shown, according to an exemplary embodiment. The summary table 2600 indicates a percentage of time of a duration that each of the spaces had PM2.5 particulate ratios in various ranges. The ratios can be a ratio of indoor PM2.5 for a particular space to outdoor PM2.5 particulate. Thus, if indoor PM2.5 is the same as the outdoor PM2.5, the ratio can be 1. If the indoor PM2.5 is less than the outdoor PM2.5, the ratio can be less than 1. If the indoor PM2.5 is greater than the outdoor PM2.5, the ratio can be greater than 1.

The PM2.5 levels shown in the table 2600 can be for occupied hours, e.g., school hours Monday through Friday 7 AM through 3 PM. The levels may be PM2.5 particulate ratios of 0-0.5, 0.5-0.75, 0.75-1.25, 1.25-2, and 2-10. The table 2600 can indicate temporal information for each space, e.g., the percentage of time in each range. Furthermore, the table 2600 can provide a peer comparison, e.g., a comparison of spaces against each other, the equipment of each space, and/or the user of each space.

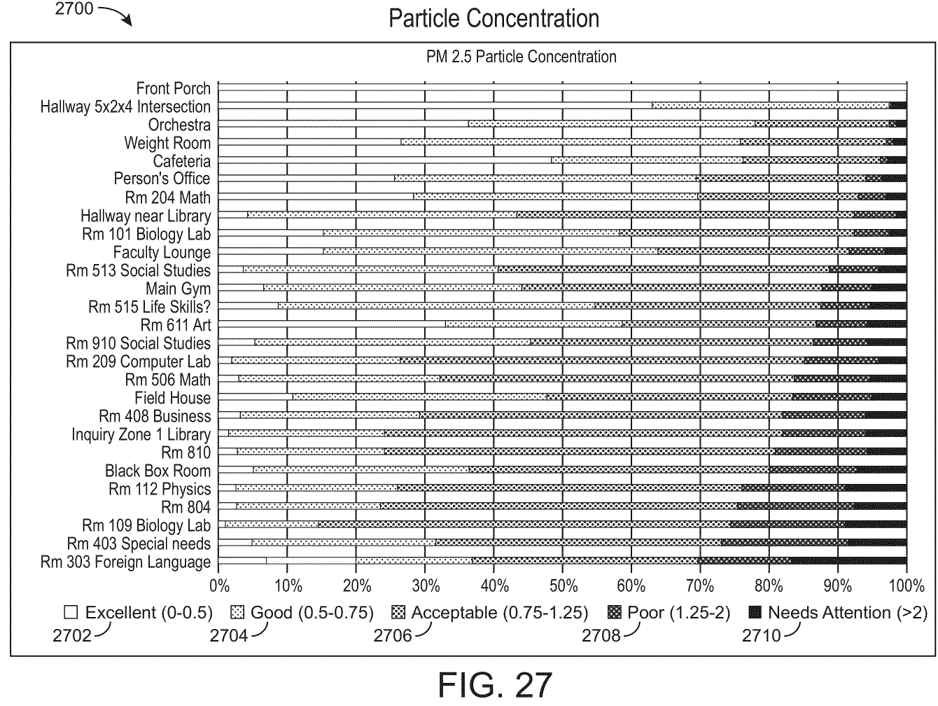

Referring now to FIG. 27, a chart 2700 of PM2.5 particulate for various spaces of the building indicating percentages of time that a ratio of indoor PM2.5 particulate to outdoor PM2.5 particulate is in particular ranges is shown, according to an exemplary embodiment. The chart 2700 compares the PM2.5 particulate ratios (e.g., a ratio of indoor PM2.5 to outdoor PM2.5) levels of various spaces with a bars. The bars are divided up into various colors, patterns, or shades to indicate ranges of PM2.5 ratio.

The amount of each color, pattern, or shade for each bar indicates the percentage of time that the PM2.5 ratio for the particular space is in a particular range. First components 2702 (e.g., green) indicates an excellent range of PM2.5 ratios, e.g., from 0-0.5. Second components 2704 (e.g., light green) indicate a good range of PM2.5 ratio of 0.5-0.75. Third components 2706 (e.g., white) indicates an acceptable range of PM2.5 ratio between 0.75-1.25. Fourth component 2708 (e.g., orange) indicates a poor range of PM2.5 ratio between 1.25-2. Fifth components 2710 (e.g., red) indicates that a space needs attention since the PM2.5 ratio is greater than 2.

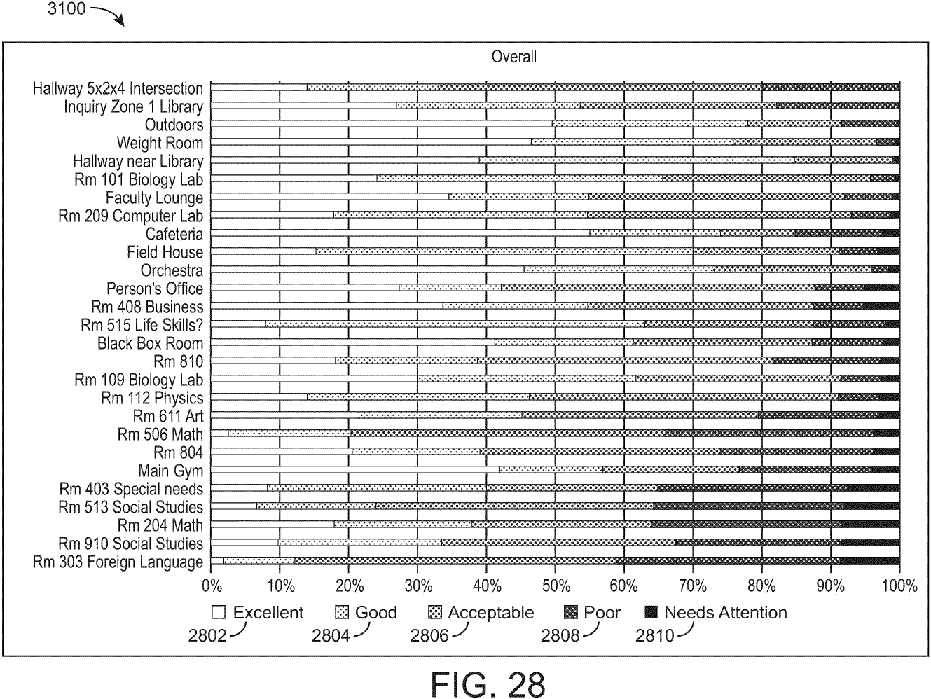

Referring now to FIG. 28, another chart 2800 of PM2.5 particulate for various spaces of the building indicating percentages of time that a ratio of indoor PM2.5 particulate to outdoor PM2.5 particulate is in particular ranges is shown, according to an exemplary embodiment. The chart 2800 again indicates PM2.5 in various components 2802-2810, excellent, good, acceptable, poor, and needs attention.

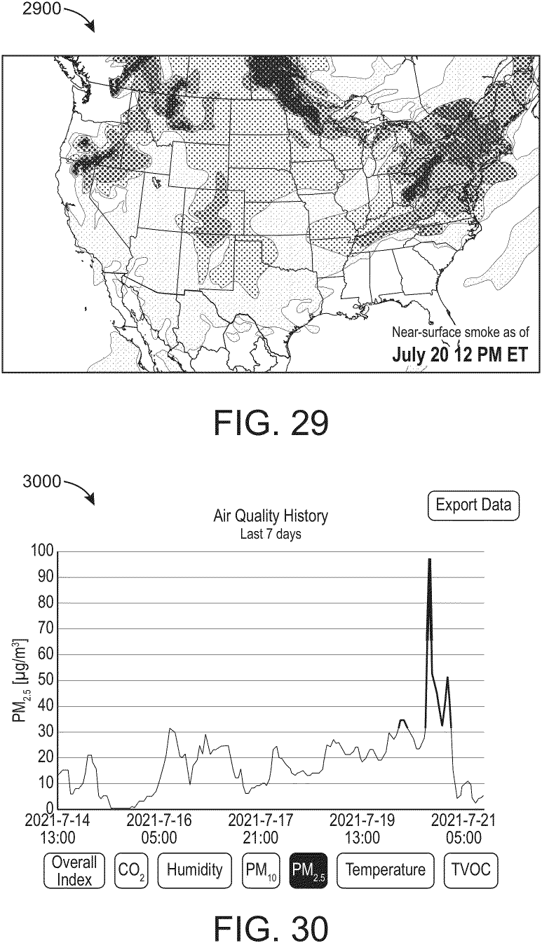

Referring now to FIG. 29, a drawing 2900 of smoke from fires moving across the United States, according to an exemplary embodiment. FIG. 30 indicates a chart 3000 of PM2.5 particulate for the school building 301. The outdoor air quality corresponds to the smoke shown in the drawing 2900. As can be seen, the spike in PM2.5 in the chart 3000 corresponds to a smoke cloud from the fire in the drawing 2900.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed:

1. A building system for a building, the building system including one or more memory devices storing instructions thereon that, when executed by one or more processors, cause the one or more processors to:
receive air quality measurements of a plurality of temporary air quality sensors over a period of time, at least one of the plurality of temporary air quality sensors is configured to:
connect to a computing system, wherein the plurality of temporary air quality sensors are installed throughout a plurality of spaces of the building for the period of time; and
disconnect from the computing system at an end of the period of time, wherein the plurality of temporary air quality sensors are uninstalled at the end of the period of time; and
generate a control strategy based on the air quality measurements, the control strategy for controlling equipment of the building to improve air quality of the building.

2. The building system of claim 1, wherein the air quality measurements are at least one of: total volatile organic compounds (TVOC);
carbon dioxide (CO2);
carbon monoxide (CO);
ozone;
particulates; or
formaldehyde.

3. The building system of claim 1, wherein the instructions cause the one or more processors to:
receive indoor air quality measurements from the plurality of temporary air quality sensors of the plurality of spaces of the building;
receive outdoor air quality measurements of outdoor air quality outside the building;
generate air quality metrics for the plurality of spaces by comparing the indoor air quality measurements to the outdoor air quality measurements; and
cause a display device of the a device to display the air quality metrics for the plurality of spaces.

4. The building system of claim 1, wherein the air quality measurements include a plurality of air quality metrics;
wherein the instructions cause the one or more processors to:
generate a plurality of trends of the plurality of air quality metrics; and
cause a display device of a user device to display the plurality of trends.

5. The building system of claim 1, wherein the instructions cause the one or more processors to:
determine an infection risk for an infectious disease spreading in a population of the building based on the air quality measurements; and
perform one or more operations to reduce a spread of the infectious disease present in the population based on the infection risk.

6. The building system of claim 1, wherein the building system is a cloud system located remote from the building, wherein the cloud system is configured to receive the air quality measurements via one or more wireless networks of the building, wherein the plurality of temporary air quality sensors are configured to wirelessly communicate via the one or more wireless networks.

7. The building system of claim 1, wherein the instructions cause the one or more processors to:
generate an infectious disease report indicating a probability of a spread of an infectious disease in the plurality of spaces of the building based on the air quality measurements; and
cause a display device of a user device to display the infectious disease report.

8. The building system of claim 1, wherein the instructions cause the one or more processors to:
cause a building management system to implement the control strategy to control the equipment of the building to improve the air quality of the building.

9. The building system of claim 8, wherein the building is a school building;
wherein the instructions cause the one or more processors to:
generate the control strategy to reduce a spread of an infectious disease among students of the school building; and
cause the building management system to implement the control strategy to control the equipment of the school building to reduce the spread of the infectious disease among students of the school building.

10. The building system of claim 1, wherein the instructions cause the one or more processors to:
receive outdoor air quality measurements of outdoor air quality outside the building;
generate air quality metrics for the plurality of spaces by comparing indoor air quality measurements to the outdoor air quality measurements; and
cause a display device of a user device to display the air quality metrics for the plurality of spaces.

11. The building system of claim 10, wherein the air quality metrics are a ratio of the indoor air quality measurements to the outdoor air quality measurements.

12. The building system of claim 1, wherein the instructions cause the one or more processors to:
generate a summary interface based on the air quality measurements, the summary interface including a single graphical interface comparing the air quality of the plurality of spaces of the building and temporal representations of levels of the air quality in the plurality of spaces of the building over a duration; and
cause a display device of a user device to display the summary interface.

13. The building system of claim 12, wherein the summary interface is generated for a first air quality metric;
wherein the instructions cause the one or more processors to generate a second summary interface based on the air quality measurements for a second air quality metric, the second summary interface including a second single chart comparing the second air quality metric of the plurality of spaces of the building and second temporal representations of levels of the second air quality metric in the plurality of spaces of the building over the duration.

14. The building system of claim 12, wherein the single graphical interface is a bar chart including a plurality of bars for the plurality of spaces, the plurality of bars including a plurality of components indicating a percentage of time of the duration that the air quality is in a particular range of values.

15. The building system of claim 12, wherein the single graphical interface is a table including a plurality of rows and a plurality of columns;
wherein the plurality of rows indicate the plurality of spaces of the building;
wherein the plurality of columns indicate a plurality of ranges of values of the air quality;
wherein each intersection of the plurality of rows and the plurality of columns indicates a percentage of time that the air quality is in a particular range of values.

16. A method comprising:
receiving, by one or more processing circuits, air quality measurements of a plurality of temporary air quality sensors over a period of time, at least one of the plurality of temporary air quality sensors is configured to:
connect to a computing system, wherein the plurality of temporary air quality sensors are installed throughout a plurality of spaces of a building for the period of time; and
disconnect from the computing system at an end of the period of time, wherein the plurality of temporary air quality sensors are uninstalled at the end of the period of time; and
generating, by the one or more processing circuits, a control strategy based on the air quality measurements, the control strategy for controlling equipment of the building to improve air quality of the building.

17. The method of claim 16, comprising:
causing, by the one or more processing circuits, a building management system to implement the control strategy to control the equipment of the building to improve the air quality of the building.

18. The method of claim 16, comprising:
determining, by the one or more processing circuits, an infection risk for an infectious disease spreading in a population of the building based on the air quality measurements; and
performing, by the one or more processing circuits, one or more operations to reduce a spread of the infectious disease present in the population based on the infection risk.

19. The method of claim 16, comprising:
generating, by the one or more processing circuits, a summary interface based on the air quality measurements, the summary interface including a single graphical interface comparing the air quality of the plurality of spaces of the building and temporal representations of levels of the air quality in the plurality of spaces of the building over a duration; and
causing, by the one or more processing circuits, a display device of a user device to display the summary interface.

20. One or more computer readable medium storing instructions thereon that, when executed by one or more processors, cause the one or more processors to:
connect to a plurality of temporary air quality sensors installed throughout a plurality of spaces of a building for a period of time;
receive air quality measurements of the plurality of temporary air quality sensors over the period of time;
disconnect from the plurality of temporary air quality sensors at an end of the period of time, wherein the plurality of temporary air quality sensors are uninstalled at the end of the period of time;
generate a control strategy based on the air quality measurements, the control strategy for controlling equipment of the building to improve air quality of the building; and
cause a building management system to implement the control strategy to control the equipment of the building to improve the air quality of the building.
